(19) United States
(12) Patent Application Publication
(10) Pub. No.: US 2006/0110111 A1
(43) Pub. Date: May 25, 2006

(54) Editing of real time information on a record carrier

(75) Inventors: Wilhelmus Jacobus Van Gestel, Eindhoven (NL); Declan Patrick Kelly, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/537,876

(22) PCT Filed: Dec. 10, 2003
(86) PCT No.: PCT/IB03/05837

§ 371 Date: Jun. 7, 2005

(30) Foreign Application Priority Data
Dec. 10, 2002 (EP) 02080613.9

(51) Int. Cl. G02B 6/255

(52) U.S. Cl. 385/95

(57) ABSTRACT

A device for real-time recording information has a file subsystem for storing the real-time information according to predefined allocation rules, including a predefined extent length (N). The device has an application subsystem for managing application control information, which includes clips (291,292) of the real-time information, a playlist of playitems indicating parts to be played of the real-time information in the clip. A bridge clip (293) is provided for linking a first and a second playitem based on re-encoded real-time information from an ending part of the first clip and a starting part of the second clip. The file subsystem is arranged for copying additional units of real-time information (294) from the first clip and/or the second clip for creating the bridge clip stream having at least the predefined extent length, and the application subsystem is arranged for adapting the application control information for accessing the bridge clip stream including said additionally copied units. In borderline cases the remaining part of a preceding or following clip is completely copied to the bridge clip.

The invention relates to a device for recording real-time information on a record carrier, the device having recording means for recording data blocks based on logical addresses on the record carrier, a file subsystem for storing the real-time information in units having unit numbers (SPN) in the data blocks according to predefined allocation rules, which rules include storing a stream of real-time information that is to be reproduced seamlessly in a sequence of extents of consecutive data blocks, the extents having at least a predefined extent length, and an application subsystem for managing application control information, the application control information including at least one clip of the real-time information, the clip comprising a clip info for accessing a clip stream of the units of real-time information via the unit numbers, at least one playlist, the playlist comprising at least one playitem, the playitem indicating a part to be played of the real-time information in the clip, the playlist indicating in which order playitems have to be reproduced, and at least one bridge clip for a first and a second playitem via the bridge clip, a bridge clip stream comprising re-encoded real-time information based on an ending part of the first clip and a starting part of the second clip.

The invention further relates to a method and computer program product for controlling the recording of real-time information, and a record carrier carrying the real-time information.

In particular the invention relates to the field of recording a digital video signal on a disc like record carrier, and subsequently editing an information signal recorded earlier on said disc like record carrier.

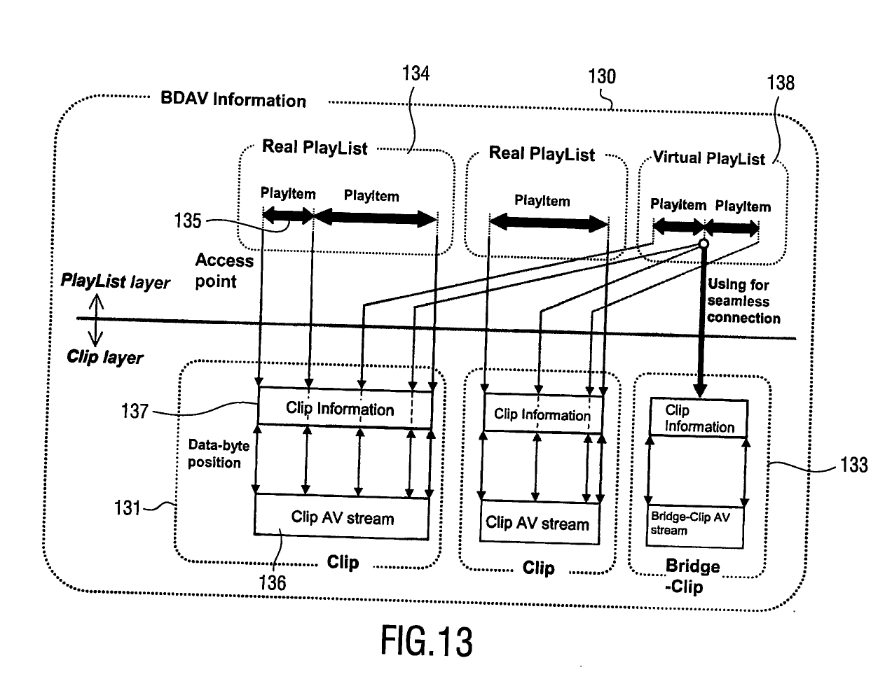

An apparatus for recording a real time information signal, such as an MPEG encoded video information signal, on a record carrier is known from WO99/48096 (PHN 17.350). The record carrier in the said document is a disc like record carrier. Further a recording system for real-time information is proposed for a high density optical disc called the Blu-ray Disc (BD), as described in the document Blue-ray Disc Rewritable Format, part 3: Audio Visual Basis Specifications, June 2002, the relevant parts of the document being substantially included in the following description with reference to FIGS. 13 to 26.

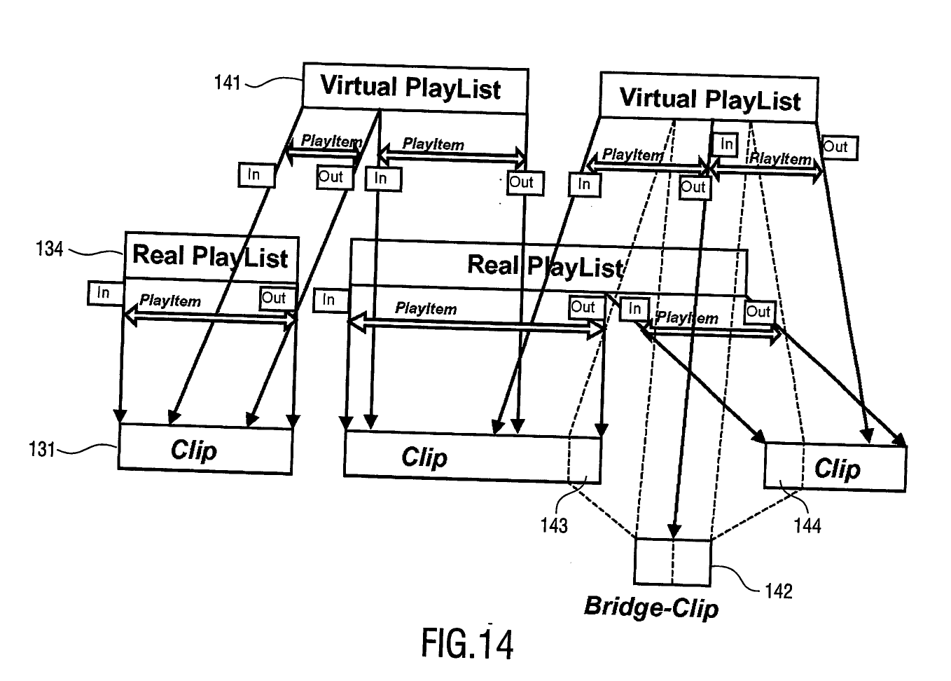

The background art describes a layered structure used in BD for recording video, the structure having a file system layer for storing the real-time information in the data blocks according to predefined allocation rules and an application layer for managing application control information as follows. Real-time information is stored in clip stream files, and corresponding control information is stored in clip info files. A playlist indicates parts of the real-time information to be reproduced via playitems. This is further explained with FIGS. 13 and 14, and detailed definitions are given of a Clip AV stream file, the Bridge Clip AV stream file, the Clip Information file, and the PlayList. In general in the clip stream file data is stored in units called source packets, and the addressing in the file is based on source packets numbers (SPN). Each clip stream file has a corresponding Clip information file. The Clip Information file has some sub-tables, which include ClipInfo, SequenceInfo and Characteristic Point Information (CPI). The PlayList contains a number of PlayItems, and the pointers in the PlayList layer are based on time axis. The pointers (addresses) to the clip stream file are based on the source packet numbers. Using the ClipInfo the timing pointers are converted to pointers to locations in the file (CPI provides entry points for decoding the real-time information). The PlayLists may be presented to the user in a Table of Contents as Titles. During playback a PlayList is selected, the PlayItems therein are analyzed, and resulting time pointers are translated into SPN of the clip stream and the source packets which are needed to be displayed are read from the disc.

In the apparatuses according to the background art, following problems exist for seamlessly linking two playitems, for example, during editing. The clips contain encoded real-time information, e.g. MPEG encoded video. Hence, when two parts of different clips (or of the same clip) are to be presented after another, a seamless presentation during this transition is not realized. To have a seamless transition following constraints should be fulfilled. The MPEG data should be continuous, e.g. a closed group of pictures (GOP) at the end of PlayItem-1 and at the beginning of PlayItem-2, and no buffer underflow or overflow of the decoding buffer in the MPEG decoder.

Seamless presentation during connection of two PlayItems is in BD realized with a so-called bridge clip. The bridge contains re-encoded real-time information from an ending part of the first clip and from a first part of the second clip. The MPEG problem is solved by the re-encoding of the last part of PlayItem-1 and the first part of Play-Item-2.

For a seamless connection only those source packets which are needed should be read in the read buffer. For preventing read buffer underflow data is stored on the record carrier according to predefined allocation rules, which for example include a minimum size of sequences of data blocks of a real-time stream for enabling the seamless connection, the sequences being called extents.

A jump is needed to jump from the end of PlayItem-1 corresponding to a first clip to the start of PlayItem-2 corresponding to a second clip. This jump requires some time, during this time interval there is no input to the read buffer, while there is still a leak rate because data is decoded for displaying. To prevent underflow of the read buffer care should be taken that the buffer is full enough to survive the jump. Buffer can only be full enough if the previous PlayItem is long enough to fill the buffer. Hence for preventing the read-buffer underflow each clip should at least have the minimum extent size. A problem of the known device occurs if the bridge clip, or the remaining part of the first or second clip, does not have the minimum extent size. The connection of such clips will not be seamless.

It is an object of the invention to provide a recording system that allows editing of real-time data and creating seamless connections, while maintaining the layered structure of file system and application control information.

For this purpose, in the device for recording as described in the opening paragraph, the file subsystem is arranged for copying additional units of real-time information from a part of the first clip stream before the ending part of the first clip and/or from a part of the second clip stream after the starting part of the second clip for creating the bridge clip stream having at least the predefined extent length, and the application subsystem is arranged for adapting the application control information for accessing the bridge clip stream including said additionally copied units.

The measures of the invention have the following effect. The file subsystem is aware of the actual recorded real-time information in the stream files, and has the task to maintain the allocation rules. The file system is allowed to achieve the necessary extent sizes by copying said additional units. The application control information is adapted for, during rendering of the real-time information, accessing the bridge clip stream including the copied units. This has the advantage that a seamless connection is created via the bridge clip and the additionally copied units.

In an embodiment of the device the file subsystem is arranged for providing access information to the application subsystem for indicating the location of said additionally copied units. This has the advantage that the application subsystem can adapt the application control information based on the access information.

In an embodiment of the device the file subsystem is arranged for copying the units from the first clip stream before the ending part of the first clip and/or the units from the second clip stream after the starting part of the second clip for creating the bridge clip, and the application subsystem is arranged adapting the application control information for accessing the bridge clip and skipping the first clip stream and/or the second clip stream. Due to copying the remaining units of a stream to the bridge clip stream, the original first or second clip needs not be read. This has the advantage, that even in the event of short clips, a seamless connection is achieved.

These and other aspects of the invention will be apparent from and elucidated with reference to the embodiments hereafter in the figure description, in which

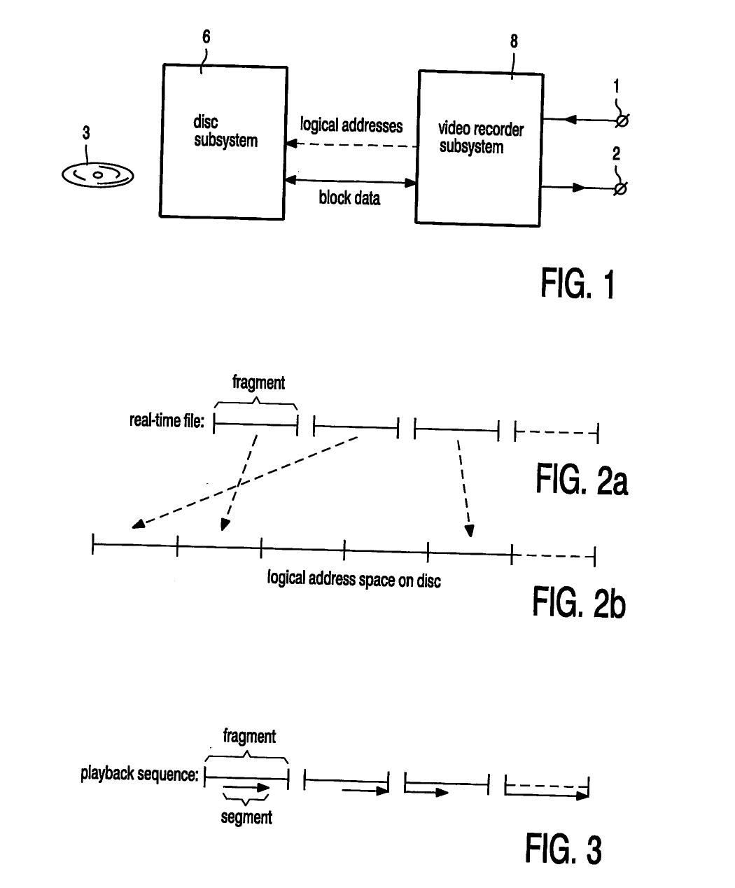

FIG. 1 shows an embodiment of the apparatus,

FIG. 2 shows the recording of blocks of information in fragment areas on the record carrier,

FIG. 3 shows the principle of playback of a video information signal,

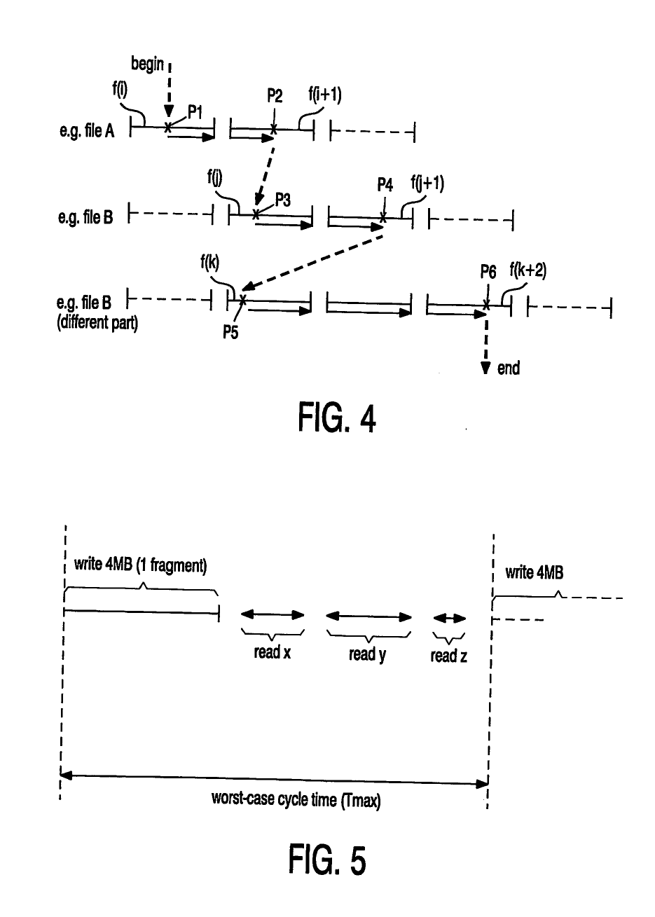

FIG. 4 shows the principle of editing of video information signals,

FIG. 5 shows the principle of ‘simultaneous’ play back and recording,

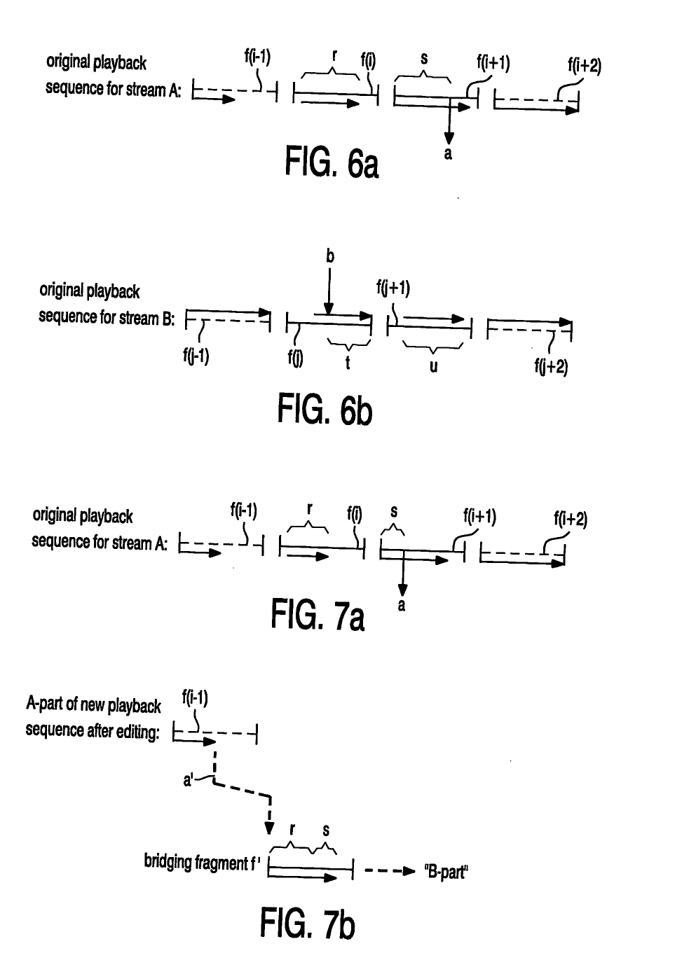

FIG. 6 shows a situation during editing when the generation and recording of a bridging block of information is not required,

FIG. 7 shows an example of the editing of a video information signal and the generation of a bridging block of information, at the location of an exit point from the information signal,

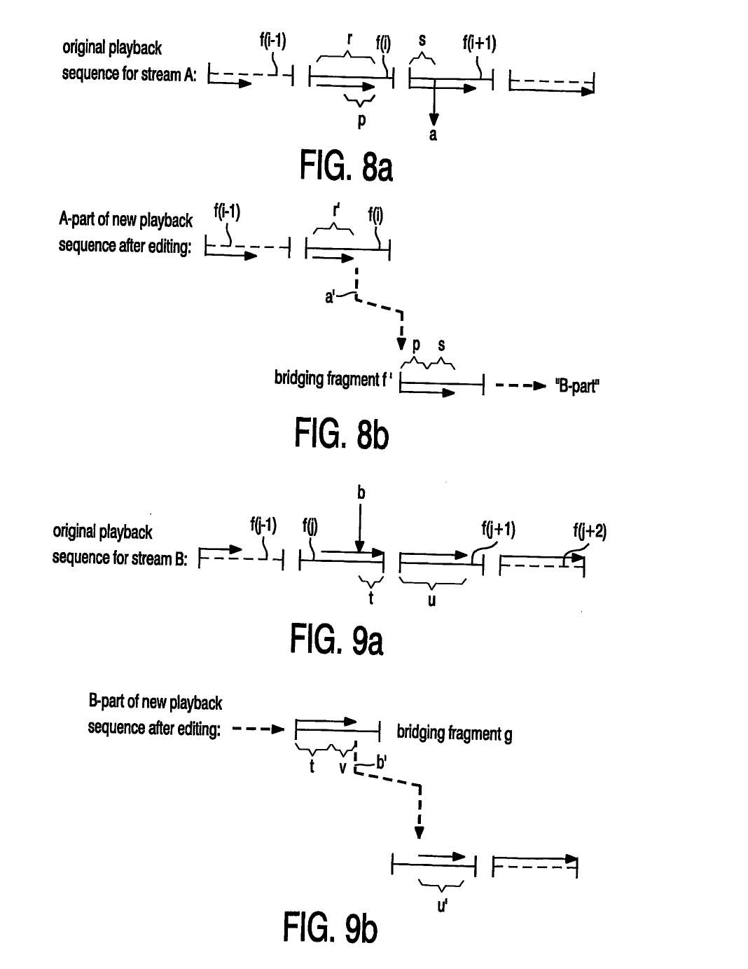

FIG. 8 shows another example of the editing of a video information signal and the generation of a bridging block of information, at the same location of the exit point as in FIG. 7,

FIG. 9 shows an example of the editing of a video information signal and the generation of a bridging block of information, at the location of an entry point to the information signal,

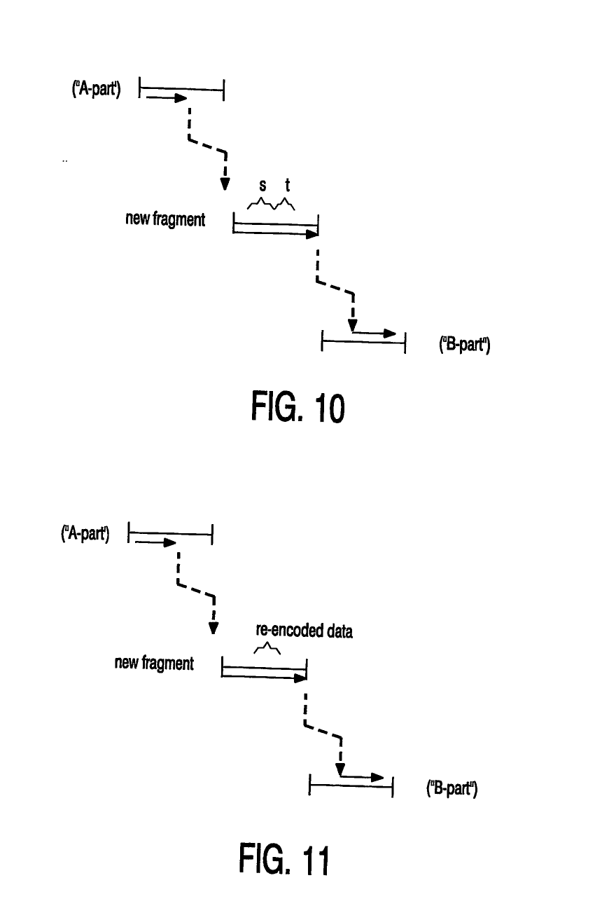

FIG. 10 shows an example of the editing of two information signals and the generation of a bridging block of information,

FIG. 11 shows an example of the editing of two information signals and the generation of a bridging block of information, where the editing includes re-encoding some of the information of the two information signals,

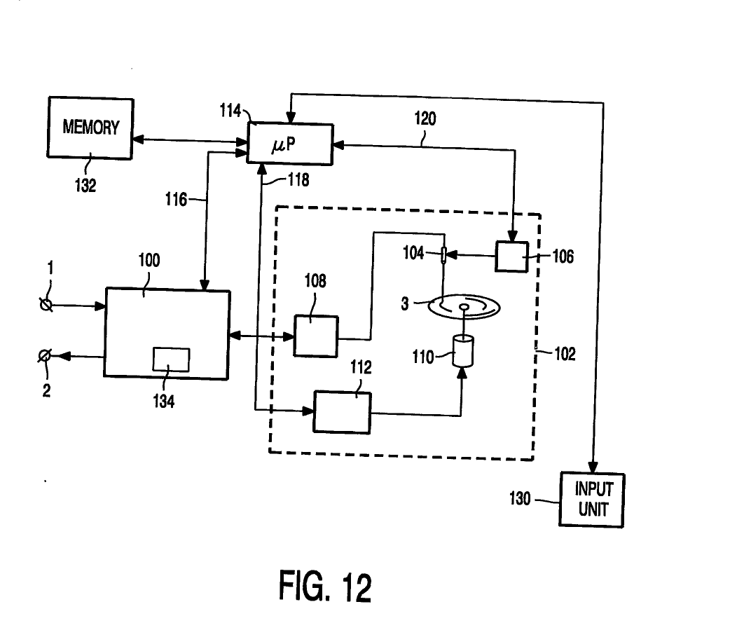

FIG. 12 shows a further elaboration of the apparatus,

FIG. 13 shows a simplified structure of the application format,

FIG. 14 shows an illustration of a real playlist and a virtual playlist,

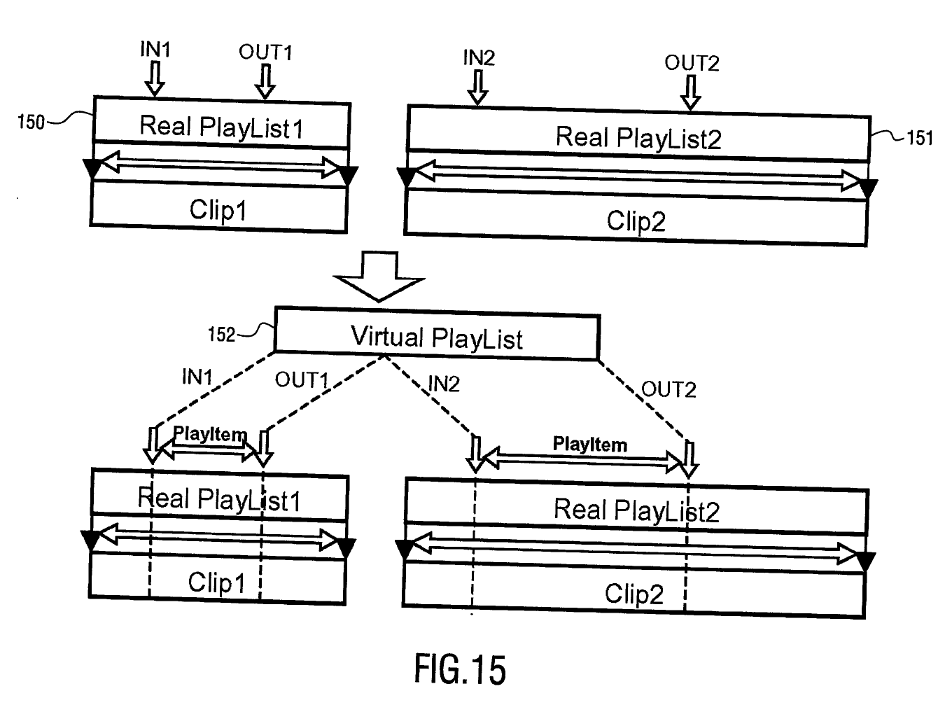

FIG. 15 shows an example of assemble editing, via a non-seamless connection between two PlayItems,

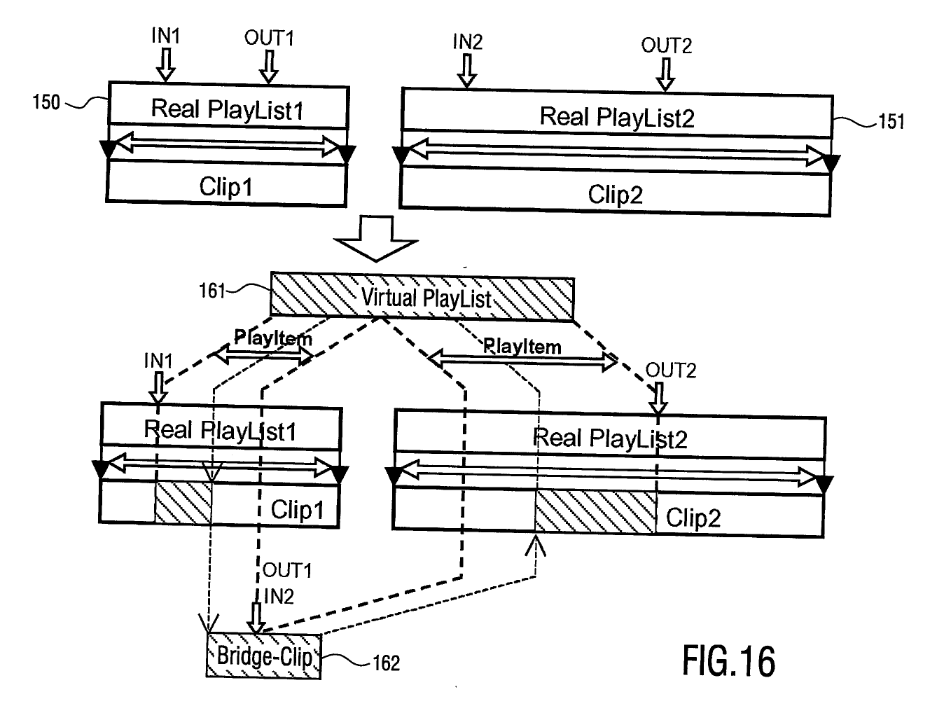

FIG. 16 shows an example of assemble editing, via a seamless connection between two PlayItems,

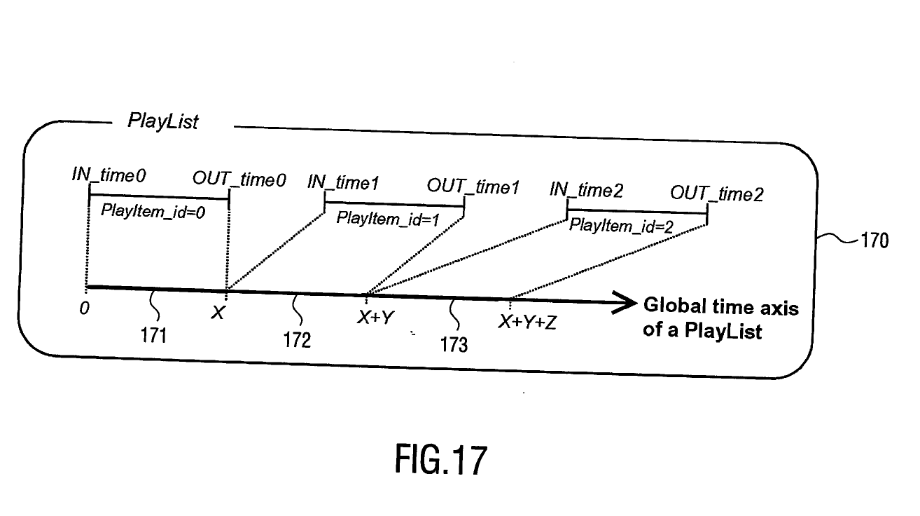

FIG. 17 shows a global time axis of a playlist,

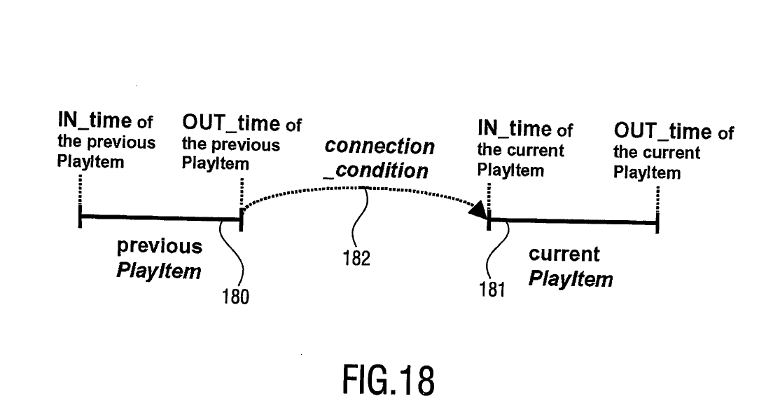

FIG. 18 shows a relationship between a current PlayItem and a previous PlayItem,

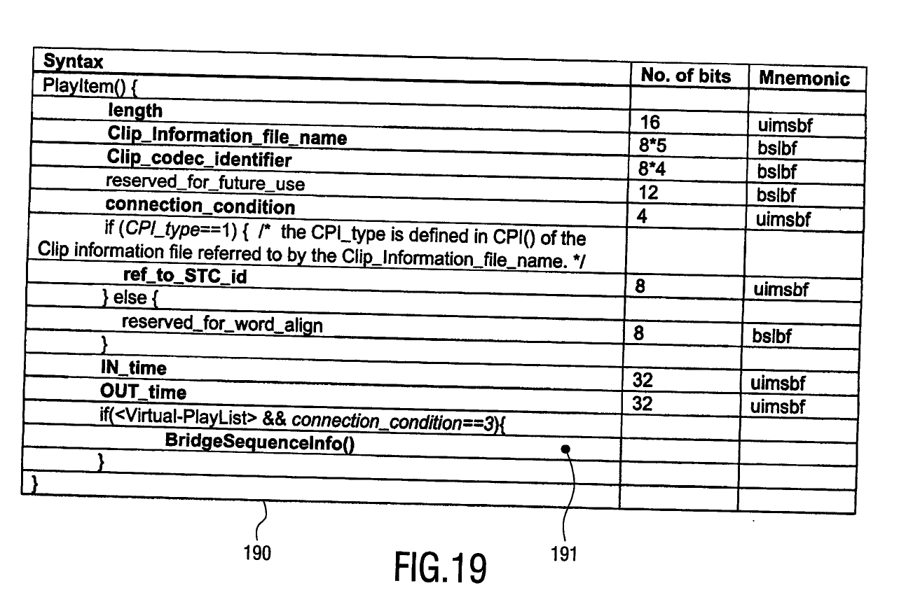

FIG. 19 shows a playitem syntax,

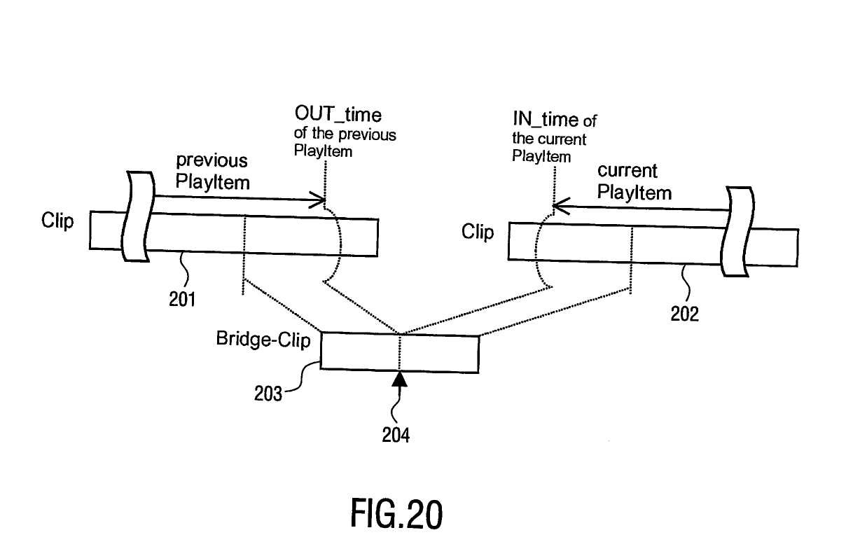

FIG. 20 shows a seamless connection via a bridge clip,

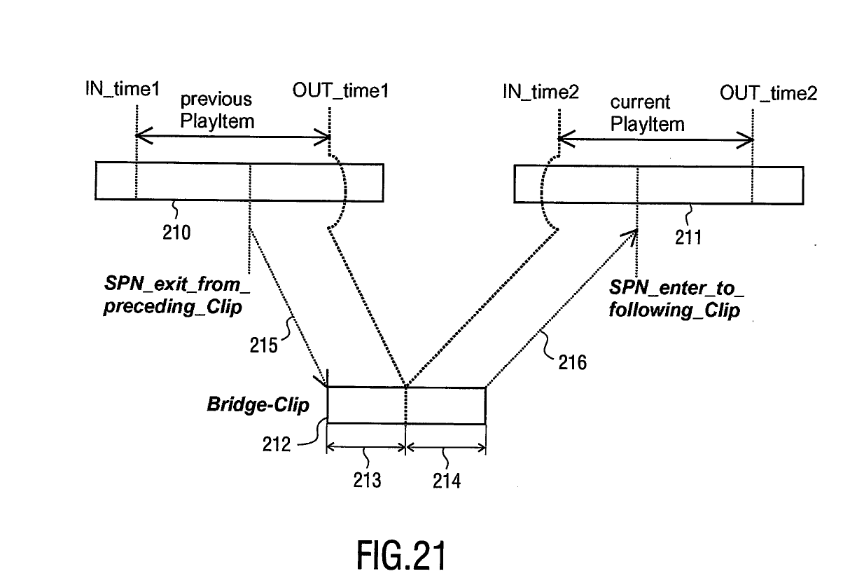

FIG. 21 shows an example of BridgeSequenceInfo,

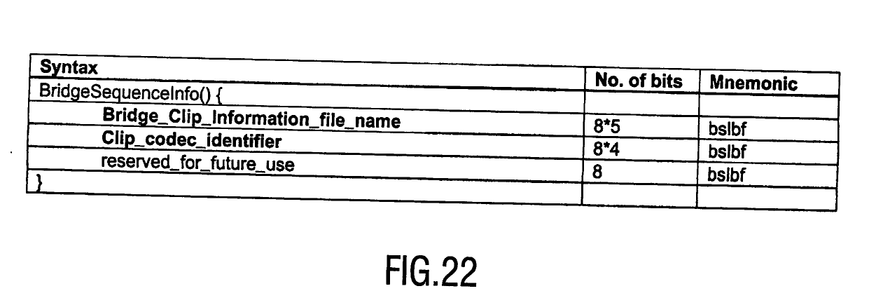

FIG. 22 shows a BridgeSequenceinfo syntax,

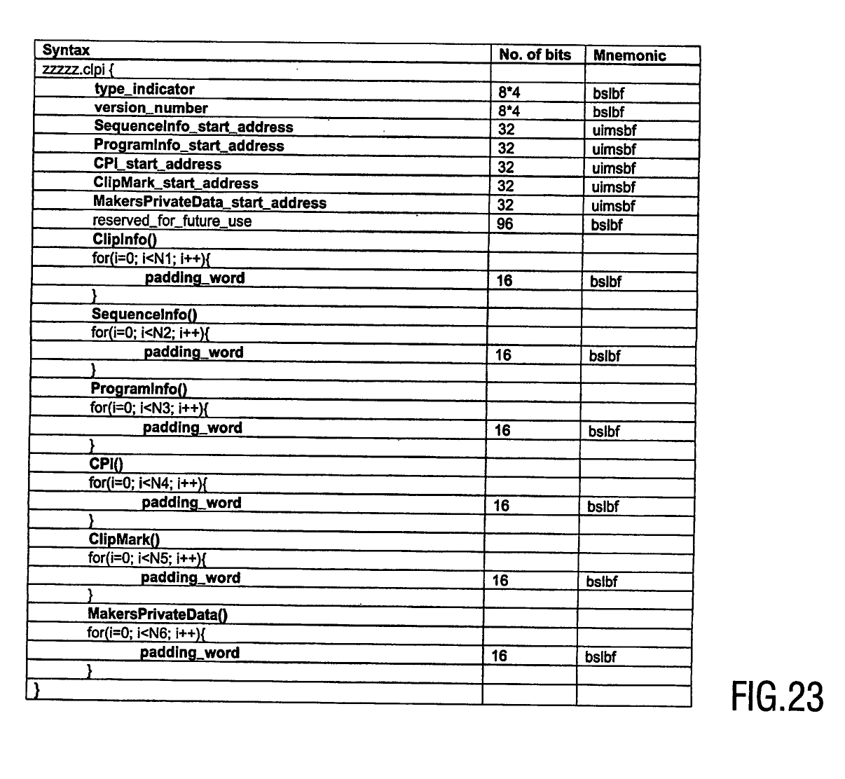

FIG. 23 shows a clip information file syntax,

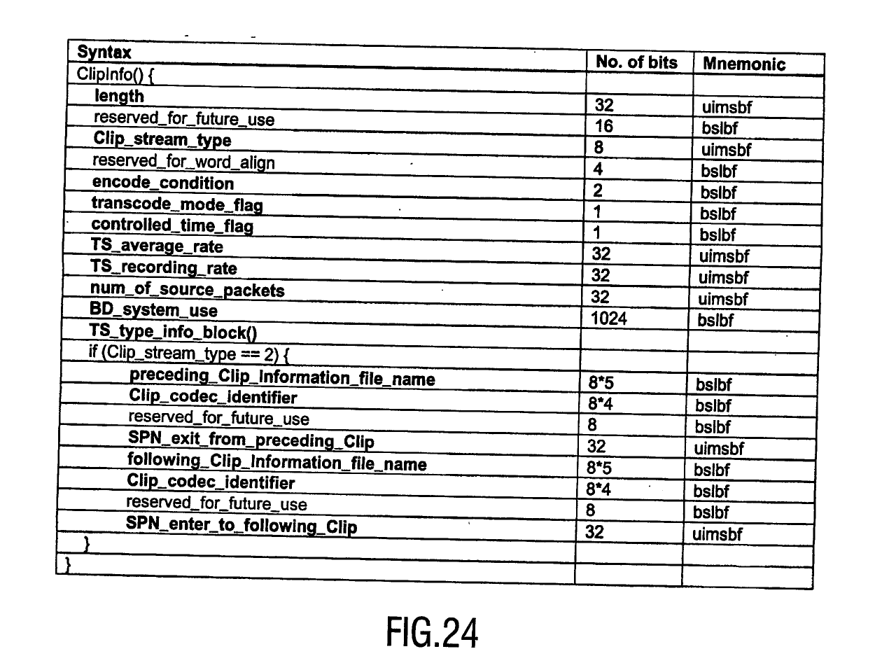

FIG. 24 shows a ClipInfo syntax,

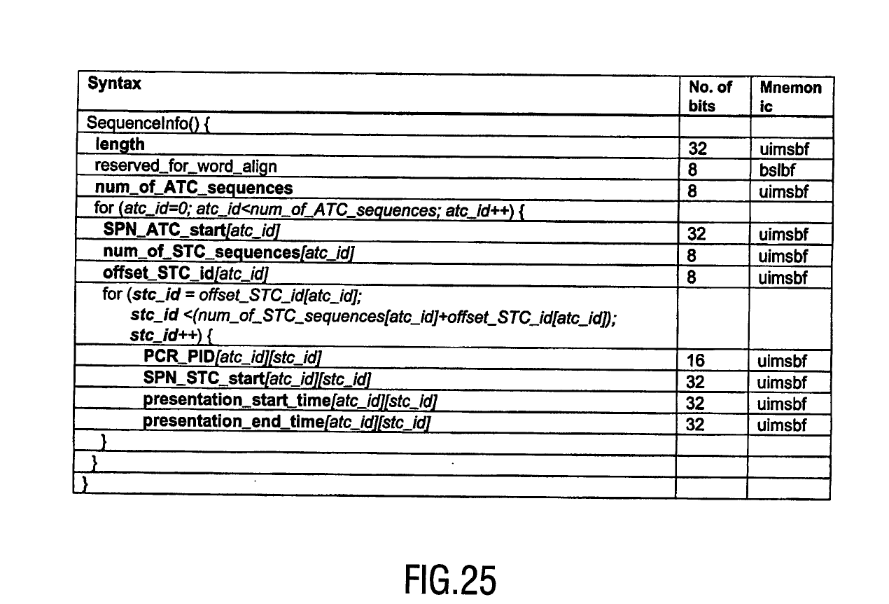

FIG. 25 shows a SequenceInfo syntax,

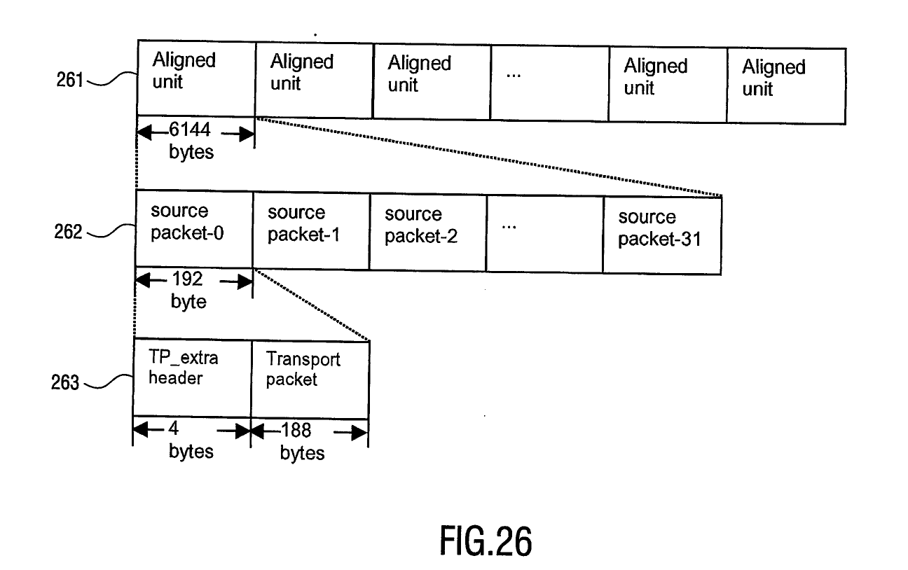

FIG. 26 shows a structure of a BDAV MPEG-2 transport stream,

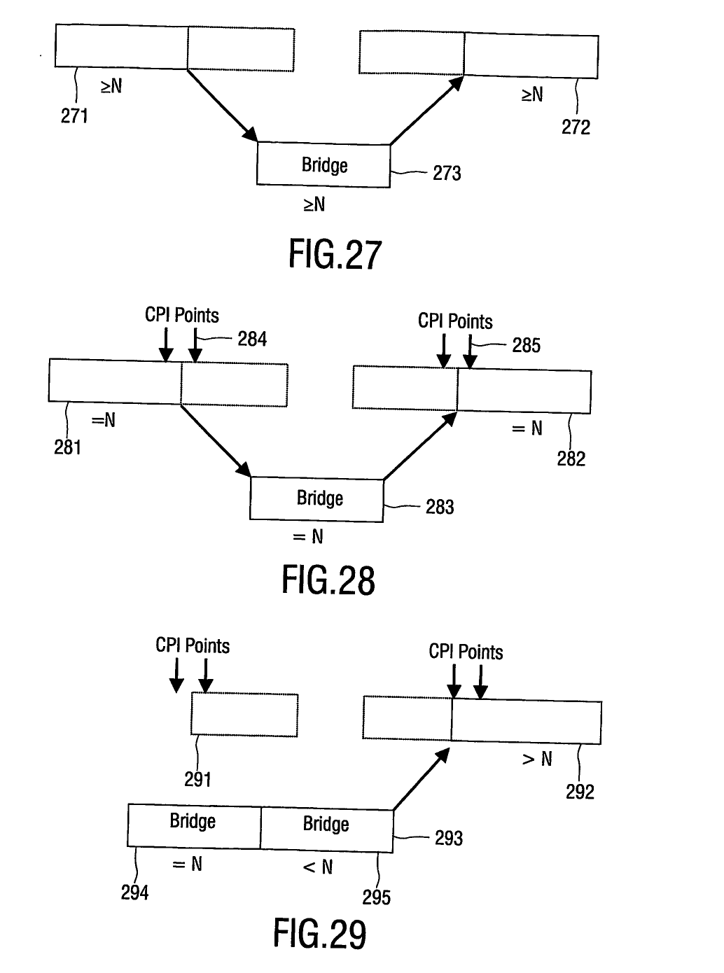

FIG. 27 shows extents and allocation rules,

FIG. 28 shows an allocation rule borderline case,

FIG. 29 shows a bridge extent wherein the data of a previous clip stream has been copied,

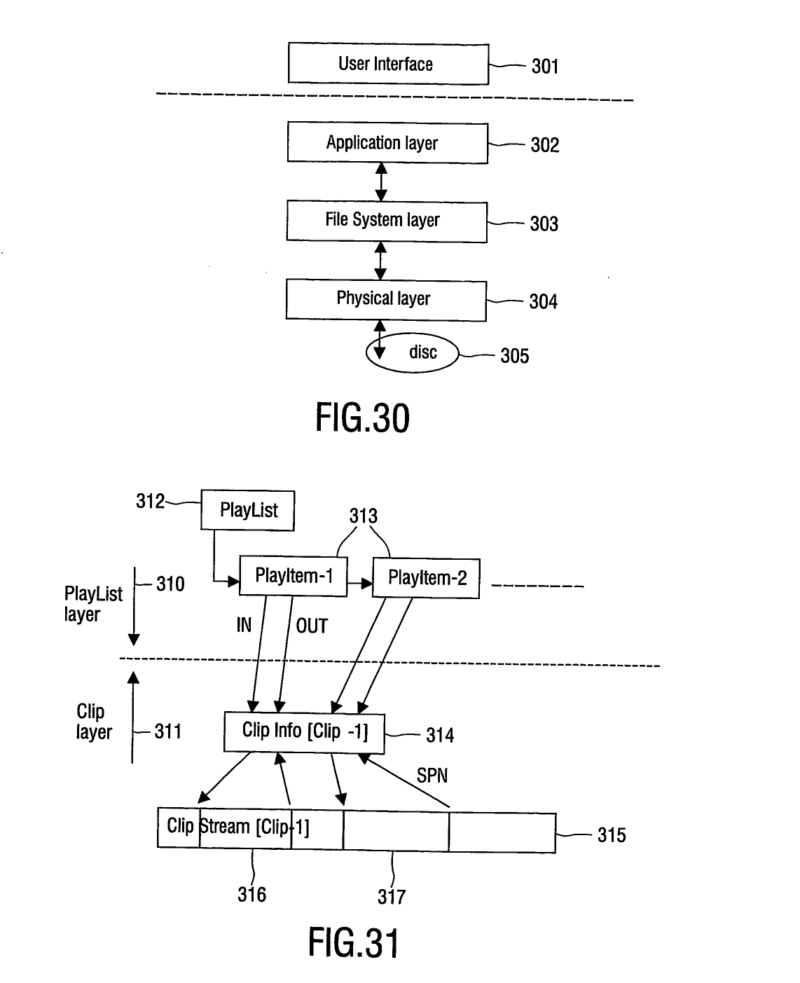

FIG. 30 shows a layered model of a real-time data recording and/or playback device,

FIG. 31 shows an application layer structure,

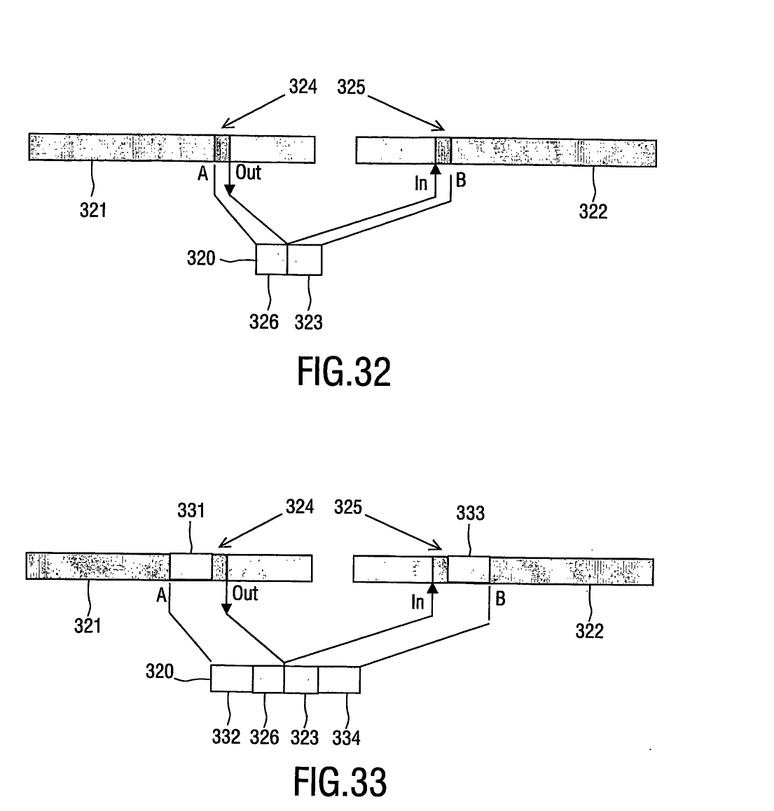

FIG. 32 shows a bridge with only re-encoded data,

FIG. 33 shows a bridge with re-encoded data and additionally copied data, and

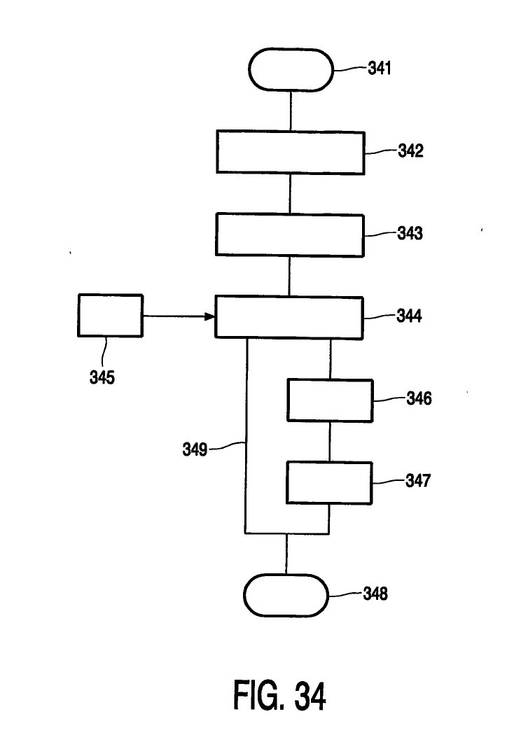

FIG. 34 shows a flow diagram of a method of controlling recording of real-time information.

Corresponding elements in different Figures have identical reference numerals.

FIG. 1 shows an embodiment of the apparatus in accordance with the invention. In the following figure description, the attention will be focussed on the recording, reproduction and editing of a video information signal. It should however be noted that other types of signal could equally well be processed, such as audio signals, or data signals.

The apparatus comprises an input terminal 1 for receiving a video information signal to be recorded on the disc like record carrier 3. Further, the apparatus comprises an output terminal 2 for supplying a video information signal reproduced from the record carrier 3. The record carrier 3 is a disc like record carrier of the magnetic or optical form.

The data area of the disc like record carrier 3 consists of a contiguous range of physical sectors, having corresponding sector addresses. This address space is divided into fragment areas. A fragment area is a contiguous sequence of sectors, with a fixed length. Preferably, this length corresponds to an integer number of ECC-blocks included in the video information signal to be recorded.

The apparatus shown in FIG. 1 is shown decomposed into two major system parts, namely a disc subsystem 6 that includes recording means and a file subsystem for controlling the recording means, and a ‘video recorder subsystem’ 8, also called application subsystem. The recording means, a detailed example being described with FIG. 12, include a unit for physically scanning the record carrier, such as a read/write head, also called optical pickup unit, a positioning servo system for positioning the head on a track, and a drive unit for rotating the record carrier. The following features characterize the two subsystems:
The disc subsystem can be addressed transparently in terms of logical addresses. It handles defect management (involving the mapping of logical addresses onto physical addresses) autonomously.
For real-time data, the disc subsystem is addressed on a fragment-related basis. For data addressed in this manner the disc subsystem can guarantee a maximum sustainable bit rate for reading and/or writing. In the case of simultaneous reading and writing, the disc subsystem handles the read/write scheduling and the associated buffering of stream data from the independent read and write channels.
For non-real-time data, the disc subsystem may be addressed on a sector basis. For data addressed in this manner the disc subsystem cannot guarantee any sustainable bit rate for reading or writing.
The video recorder subsystem takes care of the video application, as well as file system management. Hence, the disc subsystem does not interpret any of the data that is recorded in the data area of the disc.

In order to realize real time reproduction in all situations, the fragment areas introduced earlier need to have a specific size. Also in a situation where simultaneous recording and reproduction takes place, reproduction should be uninterrupted. In the present example, the fragment size is chosen to satisfy the following requirement:
fragment size=4 MB=2²² bytes

Recording of a video information signal will briefly be discussed hereafter, with reference to FIG. 2. In the video recorder subsystem, the video information signal, which is a real time signal, is converted into a real time file, as shown in FIG. 2a. A real-time file consists of a sequence of signal blocks of information recorded in corresponding fragment areas. There is no constraint on the location of the fragment areas on the disc and, hence, any two consecutive fragment areas comprising portions of information of the information signal recorded may be anywhere in the logical address space, as shown in FIG. 2b. Within each fragment area, real-time data is allocated contiguously. Each real-time file represents a single AV stream. The data of the AV stream is obtained by concatenating the fragment data in the order of the file sequence.

Next, playback of a video information signal recorded on the record carrier will be briefly discussed hereafter, with reference to FIG. 3. Playback of a video information signal recorded on the record carrier is controlled by means of a what is called ‘playback-control-program’ (PBC program). In general, each PBC program defines a (new) playback sequence. This is a sequence of fragment areas with, for each fragment area, a specification of a data segment that has to be read from that fragment. Reference is made in this respect to FIG. 3, where playback is shown of only a portion of the first three fragment areas in the sequence of fragment areas in FIG. 3. A segment may be a complete fragment area, but in general it will be just a part of the fragment area. (The latter usually occurs around the transition from some part of an original recording to the next part of the same or another recording, as a result of editing.)

Note, that simple linear playback of an original recording can be considered as a special case of a PBC program: in this case the playback sequence is defined as the sequence of fragment areas in the real-time file, where each segment is a complete fragment area except, probably, for the segment in the last fragment area of the file. For the fragment areas in a playback sequence, there is no constraint on the location of the fragment areas and, hence, any two consecutive fragment areas may be anywhere in the logical address space.

Next, editing of one or more video information signals recorded on the record carrier will be briefly discussed hereafter, with reference to FIG. 4. FIG. 4 shows two video information signals recorded earlier on the record carrier 3, indicated by two sequences of fragments named ‘file A’ and ‘file B’. For realizing an edited version of one or more video information signals recorded earlier, a new PBC program should be realized for defining the edited AV sequence. This new PBC program thus defines a new AV sequence obtained by concatenating parts from earlier AV recordings in a new order. The parts may be from the same recording or from different recordings. In order to play back a PBC program, data from various parts of (one or more) real-time files has to be delivered to a decoder. This implies a new data stream that is obtained by concatenating parts of the streams represented by each real-time file. In the FIG. 4, this is illustrated for a PBC program that uses three parts, one from the file A and two from the file B.

FIG. 4 shows that the edited version starts at a point P₁ in the fragment area f(i) in the sequence of fragment areas of figure A and continues until point P₂ in the new fragment area f(i+1) of file A. Then reproduction jumps over to the point P₃ in the fragment area f(j) in file B and continues until point P₄ in fragment area f(j+2) in file B. Next reproduction jumps over to the point P₅ in the same file B, which may be a point earlier in the sequence of fragment areas of file B than the point P₃, or a point later in the sequence than the point P₄.

Next, a condition for seamless playback during simultaneous recording will be discussed. In general, seamless playback of PBC programs can only be realized under certain conditions. The most severe condition is required to guarantee seamless playback while simultaneous recording is performed. One simple condition for this purpose will be introduced. It is a constraint on the length of the data segments that occur in the playback sequences, as follows: In order to guarantee seamless simultaneous play of a PBC program, the playback sequence defined by the PBC program shall be such that the segment length in all fragments (except the first and the last fragment area) shall satisfy:
2 MB≦segment length≦4 MB

The use of fragment areas allows one to consider worst-case performance requirements in terms of fragment areas and segments (the signal blocks stored in the fragment areas) only, as will be described hereafter. This is based on the fact that single logical fragments areas, and hence data segments within fragment areas, are guaranteed to be physically contiguous on the disc, even after remapping because of defects. Between fragment areas, however, there is no such guarantee: logically consecutive fragment areas may be arbitrarily far away on the disc. As a result of this, the analysis of performance requirements concentrates on the following:
a. For playback, a data stream is considered that is read from a sequence of segments on the disc. Each segment is contiguous and has an arbitrary length between 2 MB and 4 MB, but the segments have arbitrary locations on the disc.
b. For recording, a data stream is considered that is to be written into a sequence of 4 MB fragment areas on the disc. The fragment areas have arbitrary locations on the disc.

Note that for playback, the segment length is flexible. This corresponds to the segment condition for seamless play during simultaneous record. For record, however, complete segments areas with fixed length are written.

Given a data stream for record and playback, we will concentrate on the disc subsystem during simultaneous record and playback. It is assumed that the video recorder subsystem delivers a sequence of segment addresses for both the record and the playback stream well in advance.

For simultaneous recording and playback, the disc subsystem has to be able to interleave read and write actions such that the record and playback channels can guarantee sustained performance at the peak rate without buffer overflow or underflow. In general, different R/W scheduling algorithms may be used to achieve this. There are, however, strong reasons to do scheduling in such a way that the R/W cycle time at peak rates is as short as possible:
Shorter cycle times imply smaller buffer sizes for the read and write buffer, and hence for the total memory in the disc subsystem.
Shorter cycle times imply shorter response times to user actions. As an example of response time consider a situation where the user is doing simultaneous recording and playback and suddenly wants to start playback from a new position. In order to keep the overall apparatus response time (visible to the user on his screen) as short as possible, it is important that the disc subsystem is able to start delivering stream data from the new position as soon as possible. Of course, this must be done in such a way that, once delivery has started, seamless playback at peak rate is guaranteed. Also, writing must continue uninterruptedly with guaranteed performance.

For the analysis here, a scheduling approach is assumed, based on a cycle in which one complete fragment area is written. For the analysis of drive parameters below, it is sufficient to consider the minimum cycle time under worst-case conditions. Such a worst-case cycle consists of a writing interval in which a 4 MB segment is written, and a reading interval in which at least 4 MB is read, divided over one or more segments. The cycle includes at least two jumps (to and from the writing location), and possibly more, because the segment lengths for reading are flexible and may be smaller than 4 MB. This may result in additional jumps from one read segment location to another. However, since read segments are no smaller than 2 MB, no more than two additional jumps are needed to collect a total of 4 MB. So, a worst-case R/W cycle has a total of four jumps, as illustrated in FIG. 5. In this figure, x denotes the last part of a read segment, y denoted a complete read segment, with length between 2 MB and 4 MB, and z denotes the first part of a read segment and the total size of x, y and z is again 4 MB in the present example.

In general, the required drive parameters to achieve a guaranteed performance for simultaneous recording and playback depend on major design decisions such as the rotational mode etc. These decisions in turn depend on the media characteristics.

The above formulated conditions for seamless play during simultaneous record are derived such that they can be met by different designs with realistic parameters. In order to show this, we discuss the example of a CLV (constant linear velocity) drive design here.

In the case of a CLV design, transfer rates for reading and writing are the same and independent of the physical location on the disc. Therefore, the worst-case cycle described above can be analyzed in terms of just two drive parameters: the transfer rate R and the worst-case all-in access time τ. The worst-case access time τ is the maximum time between the end of data transfer on one location and the begin of data transfer on another location, for any pair of locations in the data area of the disc. This time covers speed-up/down of the disc, rotational latency, possible retries etc., but not processing delays etc.

For the worst-case cycle described in the previous section, all jumps may be worst-case jumps of duration τ. This gives the following expression for the worst-case cycle time:
Tmax=2F/Rₜ+4.τ
where F is the fragment size: F=4 MB=33.6.10⁶ bits. In order to guarantee sustainable performance at peak user rate R, the following should hold:
F≧R.Tmax
This yields:
R≦F/Tₘₐₓ=Rₜ.F/2.(F+2Rₜ.τ)
As an example, with Rₜ=35 Mbps and τ=500 ms, we would have: R≦8.57 Mbps.

Next, editing will be further described. Creating a new PBC program or editing an existing PBC program, generally results in a new playback sequence. It is the objective to guarantee that the result is seamlessly playable under all circumstances, even during simultaneous recording. A series of examples will be discussed, where it is assumed that the intention of the user is to make a new AV stream out of one or two existing AV streams. The examples will be discussed in terms of two streams A and B, where the intention of the user is to make a transition from A to B. This is illustrated in FIG. 6, where a is the intended exit point from stream A and where b is the intended entry point into stream B.

FIG. 6a shows the sequence of fragment areas . . . , f(i−1), f(i), f(i+1), f(i+2), . . . of the stream A and FIG. 6b shows the sequence of fragment areas . . . , f(j−1), f(j), f(j+1), f(j+2), . . . of the stream B. The edited video information signal consists of the portion of the stream A preceding the exit point a in fragment area f(i+1), and the portion of the stream B starting from the entry point b in fragment area f(j).

This is a general case that covers all cut-and-paste-like editing, including appending two streams etc. It also covers the special case where A and B are equal. Depending on the relative position of a and b, this special case corresponds to PBC effects like skipping part of a stream or repeating part of a stream.

The discussion of the examples focuses on achieving seamless playability during simultaneous recording. The condition for seamless playability is the segment length condition on the length of the signal blocks of information stored in the fragment areas, that was discussed earlier. It will be shown below that, if streams A and B satisfy the segment length condition, then a new stream can be defined such that it also satisfies the segment length condition. Thus, seamlessly playable streams can be edited into new seamlessly playable streams. Since original recordings are seamlessly playable by construction, this implies that any edited stream will be seamlessly playable. As a result, arbitrarily editing earlier edited streams is also possible. Therefore streams A and B in the discussion need not be original recordings: they can be arbitrary results of earlier virtual editing steps.

In a first example, a simplified assumption will be made about the AV encoding format and the choice of the exit and entry points. It is assumed that the points a and b are such that, from the AV encoding format point of view, it would be possible to make a straightforward transition. In other words, it is assumed that straightforward concatenation of data from stream A (ending at the exit point a) and data from stream B (starting from entry point b) results in a valid stream, as far as the AV encoding format is concerned. The above assumption implies that in principle a new playback sequence can be defined based on the existing segments. However, for seamless playability at the transition from A to B, we have to make sure that all segments satisfy the segment length condition. Let us concentrate on stream A and see how to ensure this. Consider the fragment area of stream A that contains the exit point a. Let s be the segment in this fragment area that ends at point a, see FIG. 6a.

If l(s), the length of s, is at least 2 MB, then we can use this segment in the new playback sequence and point a is the exit point that should be stored in the PBC program.

However, if l(s) is less than 2 MB, then the resulting segment s does not satisfy the segment length condition. This is shown in FIG. 7. In this case a new fragment area, the so-called bridging fragment area f′ is created. In this fragment area, a bridging segment comprising a copy of s preceded by a copy of some preceding data in stream A, is stored. For this, consider the original segment r that preceded s in stream A, shown in FIG. 7a. Now, depending on the length of r, the segment stored in fragment area f(i), either all or part of r is copied into the new fragment area f:

If l(r)+l(s)≦4 MB, then all of r is copied into f, and the original segment r is not used in the new playback sequence, as illustrated in FIG. 7a. More specifically, the new exit point is the point denoted a′, and this new exit point a′ is stored in the PBC program, and later on, after having terminated the editing step, recorded on the disc like record carrier. Thus, in response to this PBC program, during playback of the edited video information stream, after having read the information stored in the fragment area f(i−1), the program jumps to the bridging fragment area f′ for reproducing the information stored in the bridging fragment area f′ and next jumps to the entry point in the video stream B to reproduce the portion of the B stream, as schematically shown in FIG. 7b.

If l(r)+l(s)>4 MB, then some part p from the end of r is copied into f′, where the length of p is such that we have
2 MB≦l(r)−l(p)≦4 MB ˆ2 MB≦l(p)+l(s)≦4 MB

Reference is made to FIG. 8, where FIG. 8a shows the original A stream and FIG. 8b shows the edited stream A with the bridging fragment area f′. In the new playback sequence, only a smaller segment r′ in the fragment area f(i) containing r is now used. This new segment r′ is a subsegment of r, viz. the first part of r with length l(r′)=l(r)−l(p). Further, a new exit point a′ is required, indicating the position where the original stream A should be left, for a jump to the bridging fragment f′. This new exit position should therefore be stored in the PBC program, and stored later on on the disc.

In the example given above, it was discussed how to create a bridging segment (or: bridging block of information) for the fragment area f′, in case the last segment in stream A (i.e. s) becomes too short. We will now concentrate on stream B. In stream B, there is a similar situation for the segment that contains the entry point b, see FIG. 9. FIG. 9a shows the original stream B and FIG. 9b shows the edited stream. Let t be the segment comprising the entry point b. If t becomes too short, a bridging segment g can be created for storage in a corresponding bridging fragment area. Analogous to the situation for the bridging fragment area f′, g will consist of a copy of t plus a copy of some more data from stream B. This data is taken from the original segment u that succeeds t in the fragment area f(j+1) in the stream B. Depending on the length of u, either all or a part of u is copied into g. This is analogous to the situation for r described in the earlier example. We will not describe the different cases in detail here, but FIG. 9b gives the idea by illustrating the analogy of FIG. 8, where u is split into v and u′. This results in a new entry point b′ in the B stream, to be stored in the PBC program and, later on, on the record carrier.

The next example, described with reference to FIG. 10, shows how a new seamlessly playable sequence can be defined under all circumstances, by creating at most two bridging fragments (f′ and g). It can be shown that, in fact, one bridging fragment area is sufficient, even if both s and t are too short. This is achieved if both s and t are copied into a single bridging fragment area. This will not be described extensively here, but FIG. 10 shows the general result.

In examples described above, it was assumed that concatenation of stream data at the exit and entry points a and b was sufficient to create a valid AV stream. In general, however, some re-encoding has to be done in order to create a valid AV stream. This is usually the case if the exit and entry points are not at GOP boundaries, when the encoded video information signal is an MPEG encoded video information signal. The re-encoding will not be discussed here, but the general result will be that some bridge sequence is needed to go from stream A to stream B. As a consequence, there will be a new exit point a′ and a new entry point b′, and the bridge sequence will contain re-encoded data that corresponds with the original pictures from a′ to a followed by the original pictures from b to b′. Not all the cases will be described in detail here, but the overall result is like in the previous examples: there will be one or two bridging fragments to cover the transition from A to B. As opposed to the previous examples, the data in the bridging fragments is now a combination of re-encoded data and some further data from the original segments. FIG. 11 gives the general flavour of this.

As a final remark, note that one does not have to put any special constraints on the re-encoded data. The re-encoded stream data simply has to satisfy the same bitrate requirements as the original stream data.

FIG. 12 shows a schematic version of the apparatus in more detail. The apparatus comprises a signal processing unit 100 which is incorporated in the subsystem 8 of FIG. 1. The signal processing unit 100 receives the video information signal via the input terminal 1 and processes the video information into a channel signal for recording the channel signal on the disc like record carrier 3. Further, a read/write unit 102 is available which is incorporated in the disc subsystem 6. The read/write unit 102 comprises a read/write head 104, which is in the present example an optical read/write head for reading/writing the channel signal on/from the record carrier 3. Further, positioning means 106 are present for positioning the head 104 in a radial direction across the record carrier 3. A read/write amplifier 108 is present in order to amplify the signal to be recorded and amplifying the signal read from the record carrier 3. A motor 110 is available for rotating the record carrier 3 in response to a motor control signal supplied by a motor control signal generator unit 112. A microprocessor 114 is present for controlling all the circuits via control lines 116, 118 and 120.

The signal processing unit 100 is adapted to convert the video information received via the input terminal 1 into blocks of information of the channel signal having a specific size. The size of the blocks of information (which is the segment mentioned earlier) can be variable, but the size is such that it satisfies the following relationship:
SFA/2≦size of a block of the channel signal≦SFA,
where SFA equals the fixed size of the fragment areas. In the example given above, SFA=4 MB. The write unit 102 is adapted to write a block of information of the channel signal in a fragment area on the record carrier.

In order to enable editing of video information recorded in an earlier recording step on the record carrier 3, the apparatus is further provided with an input unit 130 for receiving an exit position in a first video information signal recorded on the record carrier and for receiving an entry position in a second video information signal recorded on that same record carrier. The second information signal may be the same as the first information signal. Further, the apparatus comprises a memory 132, for storing information relating to the said exit and entry positions. Further the apparatus comprises a bridging block generating unit 134, incorporated in the signal processing unit 100, for generating at least one bridging block of information (or bridging segment) of a specific size. As explained above, the bridging block of information comprises information from at least one of the first and second video information signals, which information is located before the exit position in the first video information signal and/or after the entry position in the second video information signal. During editing, as described above, one or more bridging segments are generated in the unit 134 and in the edit step, the one or more bridging segment(s) is (are) recorded on the record carrier 3 in a corresponding fragment. The size of the at least one bridging block of information also satisfies the relationship:
SFA/2≦size of a bridging block of information≦SFA.

Further, the PBC programs obtained in the edit step can be stored in a memory incorporated in the microprocessor 114, or in another memory incorporated in the apparatus. The PBC program created in the edit step for the edited video information signal will be recorded on the record carrier, after the editing step has been terminated. In this way, the edited video information signal can be reproduced by a different reproduction apparatus by retrieving the PBC program from the record carrier and reproducing the edited video information signal using the PBC program corresponding to the edited video information signal.

In this way, an edited version can be obtained, without re-recording portions of the first and/or second video information signal, but simply by generating and recording one or more bridging segments into corresponding (bridging) fragment areas on the record carrier.

In the following part a practical embodiment of a high density disc recording format called Blu-ray Disc Rewritable Format, used for recording audio/video streams (BDAV) is discussed. In the embodiment the allocation rules for recording real-time data in extents and application control information is described.

FIG. 13 shows a simplified structure of the application format. The Figure is used to explain basic concepts about the application format of recording the MPEG-2 transport stream. The Figure describes a simplified structure of the application format. The application format shows application control information 130, including two layers for managing AV stream files: those are PlayList 134 and Clip 131. The BDAV Information controller manages the Clips and the PlayLists in a BDAV directory. Each pair of an AV stream file and its attribute is considered to be one object. The AV stream file is called a Clip A Vstreamfile 136 or a Bridge-Clip AV stream file, and the attribute is called a Clip Information file 137. Each object of a Clip AV stream file and its Clip Information file is called a Clip. Each object of a Bridge-Clip AV stream file and its Clip Information file is called a Bridge-Clip 133. The Bridge-Clips are special Clips that are used for special purpose described in the following.

Clip AV stream files store data that is formatted an MPEG-2 transport stream to a structure defined by this document. The structure is called the BDAV MPEG-2 transport stream. Clip AV stream files are normal AV stream files in this document. A Clip AV stream file is created on the BDAV directory, when the recorder encodes analogue input signals to an MPEG-2 transport stream and records the stream or when the recorder records an input digital broadcast stream.

A Bridge-Clip AV stream file also has the BDAV MPEG-2 transport stream structure. Bridge-Clip AV stream files are special AV stream files that are used for making seamless connection between two presentation intervals selected in the Clips. Generally, Bridge-Clip AV stream files have very small data size compared to Clip AV stream files.

Clip Information file 137, also called clip info, has the parameters for accessing the clip stream. In general, a file is regarded as a sequence of data bytes, but the contents of the AV stream file (Clip AV stream or Bridge-Clip AV stream) is developed on a time axis. The access points in the AV stream file are specified mostly with time stamp basis. When a time stamp of an access point is given to the AV stream file, the Clip Information file finds the addressing information of the position where the player should start to read the data in the AV stream file. One AV stream file has one associated Clip Information file. The clips are accessed via two types of playlists, a real playlist 134 and a virtual playlist 138.

FIG. 14 shows an illustration of a real playlist and a virtual playlist. In general the PlayList is introduced to be able to edit easily playing intervals in the Clips that the user wants to play, e.g., assemble editing without moving, copying or deleting the part of Clips in the BDAV directory. A PlayList is a collection of playing intervals in the Clips. Basically, one playing interval is called a PlayItem and is a pair of IN-point and OUT-point, that point to positions on a time axis of the Clip. Therefore a PlayList is a collection of PlayItems. Here the IN-point means a start point of a playing interval, and the OUT-point means an end point of the playing interval. There are two types of PlayList: those are a Real-PlayList 134 and a Virtual-PlayList 141. The Real-PlayList can use only Clip AV stream files, and can not use Bridge-Clip AV stream files. The Real-PlayList is considered that it comprises its referring parts of Clips. So, the Real-PlayList is considered that it occupies the data space that is equivalent to its referring parts of Clips in the disc (the data space is mainly occupied by the AV stream files). When the Real-PlayList is deleted, the referring parts of Clips are also deleted. The Virtual-PlayList 141 can use both Clip AV stream files and Bridge-Clip AV stream files 142. The bridge clip 142 contains re-encoded data from an ending part of the preceding clip 143 and from a starting part 144 of the next clip.

The Virtual-PlayList is considered that it does not have the data of Clip AV stream files but it has the data of Bridge-Clip AV stream files if it uses the Bridge-Clip AV stream files. When the Virtual-PlayList that does not use the Bridge-Clip AV stream files is deleted, the Clips do not change. When the Virtual-PlayList that uses the Bridge-Clip AV stream files is deleted, the Clip AV stream files and the associated Clip Information files do not change, but the Bridge-Clip AV stream files and the associated Clip Information file used by the Virtual-PlayList are also deleted.

In the User interface concept the Clips are only internal to the player/recorder-system and are not visible in the user interface of the player/recorder-system. Only the PlayLists are shown to the user. Real playlists can be used for deleting, dividing, or for combining clips, and also for deleting part of a clip. However, for editing the clips and making seamless connections virtual playlists are used.

FIG. 15 shows an example of assemble editing, via a non-seamless connection between two PlayItems in playlist 150 and playlist 151. The figure shows making PlayItems that the user wants to play by combining the PlayItems into a Virtual-PlayList 152.

FIG. 16 shows an example of assemble editing, via a seamless connection between two PlayItems in playlist 150 and playlist 151. The application format supports to make a seamless presentation through a connection point between two PlayItems by making a Bridge-Clip 162. Since it is possible to play the MPEG video stream seamlessly at the connection point, normally a small number of pictures around the connection point must be re-encoded, and the Bridge-Clip contains the re-encoded pictures. This operation makes no change in the Clip AV stream files and the associated Clip Information files.

A re-editing operation of the virtual playlist is considered as one of the following actions: Changing the IN-point and/or the OUTpoint of the PlayItem in the Virtual-PlayList, appending or inserting a new PlayItem to the VirtualPlayList, or deleting the PlayItem in the Virtual-PlayList. If the user will change the IN-point and/or the OUT-point that refers to a Bridge-Clip, the recorder should give a warning and asking for the action to the user that the Bridge-Clip will be deleted and needs to create a new Bridge-Clip for making a seamless connection. And if the answer is yes, the recorder may delete the old Bridge-Clip and may create the new Bridge-Clip. It is noted that audio information may be added to video via the virtual playlist, so called audio dubbing.

FIG. 17 shows a global time axis of a playlist. The Figure shows a playlist 170 defined by a number of playitems 171,172,173. The PlayItem specifies a time based playing interval from the INtime until the OUTtime. The playing interval basically refers to a Clip, and optionally may refer to a Clip and a Bridge-Clip. When a PlayList is composed of two or more PlayItems, the playing intervals of these PlayItems shall be placed in line without a time gap or overlap on a Global time axis of the PlayList as shown in the Figure. The Global time axis may be visible in the user interface on the system, and the user can command a start time of the playback on the global time axis to the system, e.g. the playback is started 30 minutes after the beginning in the PlayList.

FIG. 18 shows a relationship between a current PlayItem and a previous PlayItem. When the connection of two PlayItems is considered, a current PlayItem 181 is connected by a connection condition 182 to a previous PlayItem 180. These two PlayItems appear in the PlayList consecutively, and the previous PlayItem is connected immediately ahead with the current PlayItem as shown in the Figure. The “IN_time of the current PlayItem” means the IN_time of which the current PlayItem has started. The “OUT_time of the current PlayItem” means the OUT_time, which ends the current PlayItem. The “IN_time of the previous PlayItem” means the IN_time which start the previous PlayItem. The “OUT_time of the previous PlayItem” means the OUT_time which ends the previous PlayItem. When the previous PlayItem and the current PlayItem are connected in the PlayList, the current PlayItem has a connection condition 182 between the IN_time of the current PlayItem and the OUT_time of the previous PlayItem. The connection_condition field of the current PlayItem indicates the connection condition. When the previous PlayItem and the current Playitem are connected with a Bridge-Clip for a seamless connection, the current PlayItem has an additional set of parameters called BridgeSequenceInfo.

FIG. 19 shows a playitem syntax. Fields of the playitem are defined in a first column 190, while the length and type of the filds are defined in a second and third column. It is noted that the playitem contains a field BridgeSequenceInfo 191 if the connection_condition equals 3 indicating a seamless connection. The BridgeSequenceInfo gives a name of Clip Information file to specify a Bridge-Clip AV stream file. And the Clip Information file for the Bridge-Clip AV stream file gives information for the connection between the previous PlayItem and the current PlayItem as described below with semantics of preceding_Clip_Information_file_name, SPNexitfromprecedingClip, following ClipInformationfilename and SPNentertofollowingClip. The parameters of the PlayItem shown in FIG. 19 have the following semantics. A length field indicates the number of bytes of the PlayItem( ) immediately following this length field and up to the end of the PlayItem( ). A Clip_Information_file_name field specifies the name of a Clip information file for the Clip used by the PlayItem. This field shall contain the 5-digit number “zzzzz” of the name of the Clip except the extension. It shall be coded according to ISO 646. The Clipstreamtype field in the ClipInfo of the Clip information file shall indicate “a Clip AV stream of the BDAV MPEG-2 transport stream”. A Clip_codec_identifier field shall have a value indicating the video coder/decoder, e.g. “M2TS” coded according to ISO 646. The PL_CPI_type in a PlayList indicates (with the Clip_codec_identifier) a corresponding predefined map of characteristic point information (CPI). The connection_condition field indicates the connection condition between the IN_time of the current PlayItem and the OUT_time of the previous PlayItem. A few predefined values, e.g. 1 to 4, are permitted for the connection_condition. If the PlayItem is the first PlayItem in the PlayList, the connection_condition has no meaning and shall be set to 1. If the PlayItem is not the first one in the PlayList, the meanings of the connection_condition are defined further. In particular connection_condition=3 indicates a seamless connection using a bridge clip.

FIG. 20 shows a seamless connection via a bridge clip. A previous PlayItem 201 is connected to a current playitem 202 via a bridge clip 203. A seamless connection 204 is located in the bridge clip 203. The constraints on connection_condition=3 are that the condition is permitted only fro predefined types of the PL_CPI_type. The condition is permitted only for the Virtual-PlayList, and the previous PlayItem and the current PlayItem are connected with the Bridge-Clip with a clean break at the connection point. The OUT_time of the previous PlayItem shall point to a presentation end time of the last video presentation unit (in presentation order) in the first time-sequence (ATC) of the Bridge-Clip AV stream file specified by the BridgeSequenceInfo of the current PlayItem. The IN_time of the current PlayItem shall point to a presentation start time of the first video presentation unit (in presentation order) in the second time sequence (ATC) of the Bridge-Clip AV stream file specified by the BridgeSequenceInfo of the current PlayItem.

FIG. 21 shows an example of BridgeSequenceinfo. The Figure shows a previous playitem in a first (preceding) clip 210 connected to a current playitem in a second (following) clip 211 via a bridge clip 212. The bridge clip 212 has a first time sequence 213 and a second time sequence 214. The BridgeSequenceInfo is an attribute for the current PlayItem as described above. The BridgeSequenceInfo( ) contains Bridge_Clip_Information_file_name to specify a Bridge-Clip AV stream file and the associated Clip Information file, and a SPN_exit_from_preceding_Clip 215, which is a source packet number of a source packet in the first clip 210 shown in the Figure. And the end of the source packet is the point where the player exits from the first clip to the start of the Bridge-Clip AV stream file. This is defined in the ClipInfo( ) of the Bridge Clip. In a SPN_enter_to_following_Clip 216 a source packet number of a source packet in the second Clip 211 is given. And the start of the source packet is the point where the player enters to the second clip from the end of the Bridge-Clip AV stream file. This is defined in the ClipEfo( ) of the Bridge-Clip. The Bridge-Clip AV stream file contains two time-sequences (ATC). Note that the first clip 210 and the second clip 211 can be the same Clip.

FIG. 22 shows a BridgeSequenceInfo syntax. The fields in the BridgeSequenceInfo are as follows. A Bridge_Clip_Information_file_name field specifies the name of a Clip information file for the Bridge-Clip used by the BridgeSequenceInfo. The field shall contain the 5-digit number “zzzzz” of the name of the Clip except the extension. It shall be coded according to ISO 646. A Clipstreamtype field in the ClipInfo of the Clip information file shall indicate “a Bridge-Clip AV stream of the BDAV MPEG-2 transport stream”. A Clip_codec_identifier field shall identify the codes.

FIG. 23 shows a clip information file syntax. The clip information file, e.g. for a BDAV MPEG-2 transport stream, is composed of six objects defined in fields as shown, and those objects are ClipInfo( ), SequencenInfo( ), ProgramInfo( ), CPI( ), ClipMark( ) and MakersPrivateData( ). The same 5-digit number “zzzzz” shall be used for both one AV stream file (a Clip AV stream file or a Bridge-Clip AV stream file) and the associated Clip information file. The fields are as follows. A type_indicator field shall have a predefined value, e.g. “M2TS” coded according to ISO 646. A version_number is a four-character string that indicates version number of the Clip Information file. SequenceInfo_start_address indicates the start address of the SequenceInfo( ) in relative byte number from the first byte of the Clip Information file. The relative byte number starts from zero. A Programinfo_start_address indicates the start address of the ProgramInfo( ) in relative byte number from the first byte of the Clip Information file. The relative byte number starts from zero. A CPI_start_address indicates the start address of the CPI( ) in relative byte number from the first byte of the Clip Information file. The relative byte number starts from zero. A ClipMark_start_address indicates the start address of the ClipMark( ) in relative byte number from the first byte of the Clip Information file. The relative byte number starts from zero.

A MakersPrivateData_start_address indicates the start address of the MakersPrivateData( ) in relative byte number from the first byte of the Clip Information file. The relative byte number starts from zero. If this field is set to zero, there is no data for the MakersPrivateData( ). This rule is applied only for the MakersPrivateData_start_address. Padding words shall be inserted according to the syntax of zzzzz.clpi. Each padding_word may have any value.

FIG. 24 shows a ClipInfo syntax. The table in the Figure defines the syntax of ClipInfo( ) in a Clip Information file. The ClipInfo( ) stores the attributes of the associated AV stream file (the Clip AV stream or the BridgeClip AV stream) in the following fields. A length field indicates the number of bytes of the ClipInfo( ) immediately following this length field and up to the end of the ClipInfo( ). A Clip_stream_type indicates a type of the AV stream associated with the Clip information file, e.g. clip_stream_type=2 indicating a bridge clip. An encode_condition indicates an encoding condition of the transport stream for the Clip. A transcode_mode_flag indicates a recording way of MPEG-2 transport streams received from a digital broadcaster. A controlled_time_flag indicates a way of ‘controlled time’ recording. A TS_average_rate and TSrecordingrate indicate rates of the transport stream for calculation.

A num_of source_packets field shall indicate the number of source packets stored in the AV stream file associated with the Clip Information file. A BD_system_use field contains the content protection information for the AV stream file associated with the Clip Information file. If the Clip_stream_type indicates the Clip is a Bridge-Clip AV stream file, then a preceding_Clip_Information_file_name specifies the name of a Clip Information file associated with a Clip AV stream file that is connected ahead with the Bridge-Clip AV stream file. This field shall contain the 5-digit number “zzzzz” of the name of the Clip except the extension. The name shall be coded according to ISO 646. The Clip indicated by this field is the first Clip 210 shown in FIG. 21. A SPN_exit_from_preceding_Clip field indicates a source packet number of a source packet in a Clip specified by the preceding_Clip Information_file_name. And the end of the source packet is the point where the player exits from the Clip to the start of the Bridge-Clip AV stream file. This means that the source packet pointed to by the SPN_exit_from_preceding_Clip is connected with the first source packet of the Bridge-Clip AV stream file, as indicated in FIG. 21. If the Clip_stream_type indicates the Clip is a Bridge-Clip AV stream file, then the following_Clip_Information_file_name specifies the name of a Clip Information file associated with a Clip AV stream file that is connected behind with the Bridge-Clip AV stream file. This field shall contain the 5-digit number “zzzzz” of the name of the Clip except the extension. The name shall be coded according to ISO 646. The Clip indicated by this field is the second clip 211 shown in FIG. 21. A SPN_enter_to_following_Clip field indicates a source packet number of a source packet in a Clip specified by the following_Clip_Information_file_name. And the start of the source packet is the point where the player enters to the Clip from the end of the Bridge-Clip AV stream file. This means that the last source packet of the Bridge-Clip AV stream file is connected with the source packet indicated by the SPN_enter_to_following_Clip, as indicated in FIG. 21.

FIG. 25 shows a SequenceInfo syntax. The SequenceInfo stores information to describe time sequences (ATC and STC-sequences) for the AV stream file. ATC is a time-line based on the arrival time of each source packet in the AV stream file. The sequence of source packets that includes no arrival time-base (ATC) discontinuity is called an ATC-sequence. When making a new recording of Clip AV stream file, the Clip shall contain no arrival time-base discontinuity, i.e. the Clip shall contain only one ATC-sequence. It is supposed that the arrival time base discontinuities in the Clip AV stream file may only occur in case the parts of the Clip AV stream are deleted by editing and the needed parts originated from the same Clip are combined into a new Clip AV stream file. The SequenceInfo( ) stores addresses where the arrival time-bases start. The SPN_ATC_start indicates the address. The first source packet of the ATC-sequence shall be the first source packet of an Aligned unit. A sequence of source packets that includes no STC discontinuity (system time-base clock discontinuity) is called an STC-sequence. The 33-bit counter of STC may wrap-around in the STC-sequence. The SequenceInfo( ) stores addresses where the system time-bases start. The SPN_STC_start indicates the address. The STC-sequence except the last one in the AV stream file starts from the source packet pointed to by the SPN_STC_start, and ends at the source packet immediately before the source packet pointed to by the next SPN_STC_start. The last STC-sequence starts from the source packet pointed to by the last SPN_STC_start, and ends at the last source packet. No STC-sequence can overlap the ATC-sequence boundary.

The fields in the SequenceInfo are as follows. A length field indicates the number of bytes of the SequenceInfo( ) immediately following this length field and up to the end of the SequenceInfo( ). A num_of_ATC sequences indicates the number of ATC-sequences in the AV stream file (Clip AV stream file or Bridge-Clip AV stream file). A SPNATCstart[atcid] field indicates a source packet number of a source packet where the ATC-sequence pointed to by atc_id starts in the AV stream file. A num_of_STC_sequences[atc-id] field indicates the number of STC-sequences on the ATC-sequence pointed to by the atc_id. An offset_STC_id[atc_id] field indicates the offset stc_id value for the first STC-sequence on the ATC-sequence pointed to by the atc_id. A SPN_STC_start[atc_id][stc_id] field indicates a source packet number of a source packet where the STC-sequence pointed to by the stc_id on the ATC-sequence pointed to by the atc_id starts. A presentation_start_time[atc_id][stc_id] field indicates a presentation start time of the AV stream data for the STC-sequence pointed to by the stc_id on the ATC-sequence pointed to by the atc_id. A presentation_end_time[atc_id][stc_id] field indicates a presentation end time of the AV stream data for the STC-sequence pointed to by the stc_id on the ATC-sequence pointed to by the atc_id. The presentation times are measured in units of a 45 kHz clock derived from the STC of the STC-sequence. Further details about the time sequences are described in the BD format.

FIG. 26 shows a structure of a BDAV MPEG-2 transport stream. The AV stream files have the structure of BDAV MPEG-2 transport stream. The BDAV MPEG-2 transport stream is constructed from an integer number of Aligned units 261. The size of an Aligned unit is 6144 bytes, which corresponds to 3 data blocks of 2048 bytes. The Aligned unit starts from the first byte of source packets 262. The length of a source packet is 192 bytes. One source packet 263 consists of a TP_extra_header and a transport packet. The length of TP_extra_header is 4 bytes and the length of transport packet is 188 bytes. One Aligned unit consists of 32 source packets 261. The last Aligned unit in the BDAV MPEG-2 transport stream also consists of 32 source packets. So, the BDAV MPEG-2 transport stream terminates at the end of an Aligned unit. If the last Aligned unit is not completely filled with input transport stream to be recorded on the volume, the remaining bytes shall be filled with source packets with Null packet (transport packet with PID=0x1FFF).

The invention aims at providing measures to enable a seamless connection while maintaining the PlayList structure which applies timing information as described above.

The ClipInfo from a Bridge-clip according to the invention contains the SPN of the last Source packet which has to be read in the previous PlayItem and it contains the SPN where the reading of the current PlayItem should start. Now the procedure for creating a bridge clip is as follows. The PlayList is selected, and the PlayItems are investigated. If there is a connection=3 between two PlayItems then it is known that the connection is realized with a bridge clip. So there is a reference to the bridgeclip name, as indicated in FIG. 19. The ClipInfo of this bridge clip has the SPN-exit from preceding clip and the SPN-enter to following clip, as indicated in FIG. 24. In BD there is an allocation rule that says that each contiguous extent must have a minimum size of N (for example N=12 MB). When editing with a bridge sequence, it is necessary to ensure that the extent before the bridge sequence, the bridge sequence itself and the segment after the bridge sequence all satisfy the minimum extent size. The minimum extents size is achieved by the file system by copying additional source packets from the clip preceding and/or following the bridge as explained in the embodiments below.

FIG. 27 shows extents and allocation rules. A first stream file of a first clip is stored in a first extent 271, which complies with the allocation rule that the length ≧N. A second stream file of a second clip is stored in a second extent 272, which also complies with the allocation rule that the length ≧N. A bridge clip stream file is stored in a third extent 273, which also complies with the allocation rule that the length ≧N.

FIG. 28 shows an allocation rule borderline case. A first stream file of a first clip is stored in a first extent 281, which just complies with the allocation rule because the length is approximately N. A second stream file of a second clip is stored in a second extent 282, which also just complies with the allocation rule because the length is approximately N. A bridge clip stream file is stored in a third extent 273, which also just complies with the allocation rule because the length is approximately N. Note that with an addressing scheme based on source packet numbers (as indicated in the Figure) this is no problem, because lengths of the extents could be based on the source packets. However, the jump to/from the bridge is to be addressed using time indicators as discussed above, and CPI is used to resolve the time to location of the source packets. Hence the points in CPI determine where the jump is to be made. Due to the CPI in the current situation there is a need to either copy more or less data from the original streams to the bridge—and either one will violate the allocation rule. In an embodiment of the invention one of the extents is copied from the original sequence to the bridge which is shown in the following Figure.

FIG. 29 shows a bridge extent wherein the data of a previous clip stream has been copied. A previous clip stream 291 has been completely copied to a bridge stream file in a first part 294 of a bridge 293. A re-encoded part 295 of the bridge stream file is smaller than the minimum extent size N, but the allocation rules are not violated because of the immediately preceding part 294. It is to be noted that also the following clip 292 could have been copied to the bridge, or both clips.

In fact, depending on how the allocation is done, the result could be much worse. If do allocation is done in blocks of N then when the bridge is created, there is a need to copy either substantially all of an extent or none of it. However, the CPI locations are based on the video content. The CPI locations are not related to the allocation extents, so in general the CPI points will never correspond to the start of an allocation extent. In an embodiment the problem is more severe in an allocation scheme wherein the minimum allocation extent size equals the fragment size.

In an embodiment an addressing scheme is used based on copying source packets. In general it may be necessary in some cases to copy more extents to the bridge sequence. By using the packet based addressing the number of cases of copying full extents is reduced to a minimum. Copying additional data to the bridge is explained in detail in the following part.

FIG. 30 shows a layered model of a real-time data recording and/or playback device. In a user interface layer 301 a user of the device is provided with information about the status of the device, and with user controls, e.g. a display, buttons, a cursor, etc. In an application layer 302 files are made, and stored/retrieved via a file system layer 303. The addressing within the files is based on byte number for the data files and on source packets for the real-time files (audio and video files). In the File System layer (FS) the files are allocated on Logical Blocks of the Logical volume. Tables are kept in the file system layer with the mapping of the files on the Logical address space. A physical layer 304 takes care of the translation from Logical Block numbers to physical addresses and interfaces with the record carrier 305 for writing and reading data blocks based on the physical addresses. Within the Application layer 302 an application layer structure is applied.

FIG. 31 shows an application layer structure. There is a PlayList layer 310 and a Clip layer 311. A PlayList 312 concatenates a number of PlayItems 313. Each PlayItem contains an IN-time and an OUT-time and a reference to a Clip file 314. The addressing in the PlayList layer is time based. The addressing in the Clip layer to a stream file 315 is based on Source packet numbers for indicating parts 316,317 to be played from the clip stream. Using the ClipInfo file 314 the translation from the time base to the location in the stream file 315 is carried out. Now it is known what parts from the stream file should be read. The application sends a message to the FS with the source packet numbers that have to be read. The FS translates this in the Logical blocks that have to be read. A command is given to the Physical layer 304 to read and send back these logical blocks.

When two parts of one (or two different) clip(s) are to be presented after another, this is usually called editing. In general seamless presentation during such a transition is not realized. To have a seamless transition, for example, the following constraints should be fulfilled: the MPEG data should be continuous (e.g. a closed GOPs at the end of PlayItem-1 and at the beginning of PlayItem-2), no buffer underflow or overflow of the decoding buffer in the MPEG decoder), and there should not be read buffer underflow. As explained above seamless presentation during connection of two PlayItems is in BD realized with a so-called bridge. The MPEG problem is solved by re-encoding the last part of PlayItem-1 and the first part of Play-Item-2.

FIG. 32 shows a bridge with only re-encoded data. In a first playitem 321 an Out-time is set, e.g. selected by the user, and in a second playitem 322 an In-time is set. An ending part 324 before the Out-time is re-encoded, e.g. starting at time A, resulting in re-encoded data 326 constituting a first part of a bridge 320. A beginning part 325 after the In-time is re-encoded, e.g. ending at time B, resulting in re-encoded data 323 constituting a second part of the bridge 320. The re-encoding is carried out in the application layer. If now PlayItem-1 is read until A then the bridge is read and the PlayItem-2 is started at B, then the MPEG data is continuous. However at A and at B a jump has to be made. This jump requires some time, during this time interval there is no input to the read buffer, while there is still a leak rate. To prevent underflow of the read buffer, care should be taken that the buffer is full enough to survive the jump. Buffer can only be full enough if the previous PlayItem is long enough to fill the buffer. In general the bridge may be too short to fill the read buffer, which may cause underflow in the read buffer. Continuous data flow is realized in BD with the allocation rules, which include length requirements for the extents storing the stream data. The allocation rules are carried out in the FS layer. In the FS layer nothing is known about MPEG.

FIG. 33 shows a bridge with re-encoded data and additionally copied data. FIG. 33 shows the same stream data elements as shown in FIG. 32. However in addition a number of units from the first playitem 321 and/or the second playitem 322 is copied to the bridge 320 to provide a bridge stream file that has at least the minimum length according to the allocation rules. In the Figure a first amount of units 331 is copied from the first playitem 321 to the bridge as additionally copied units 332, and a second amount of units 333 is copied from the second playitem 322 to the bridge as additionally copied units 334. The amount of data that is copied depends only on the size of extents and not on the boarders of MPEG GOPs. Note that points A and B are not related anymore on GOP boarders, they are related on source packet numbers as can be seen in FIG. 24.

Usually the logical blocks (LB) are aligned on error correction blocks blocks (32 LBs in one ECC block). The ECC block is the smallest Physical block that can be written or read. In an embodiment the source packets from the files are on Aligned Units and on LBs (32 Source packets in one Aligned Unit and 3 LBs in one Aligned Unit), as shown in FIG. 26. In an embodiment the points A and B are set on boarders of an ECC block. A combination of the alignment of packets and the ECC block border result in a selectable point for A or B once every 3 ECC blocks. It is noted that encryption of data, which is common in transmission and storage of data, is also aligned on Aligned Units. Hence setting points A and B aligned as indicated is advantageous in combination with encryption.

It is noted that a packet based addressing scheme is used for the bridge. In the FS layer the presentation time is not known. The points A and B are not aligned with CPI entries (GOP boarders). The points A and B cannot be directly entered in the PlayItem because the playitem pointers are time based. Hence the application layer will enter the location of the additionally copied data in the Clip layer (in Bridge Clip Info as shown in FIG. 24). During Playback a PlayList with the PlayItems 1-2 are played. The connection condition between these PlayItems indicates that there is a Bridge for seamless presentation. The Bridge ClipInfo contains the addresses of points A and B. The application layer asks the FS layer to play Clip-1 until point A and then start with the bridge clip. The FS layer asks the Physical to read the corresponding LBs.

In an embodiment a message is transferred from FS layer to Clip layer to in indicate the additionally copied data. The application layer stores the packet based addresses in the ClipInfo. It is to be noted that the FS did not receive a direct command to copy data from the preceding and/or following clips, but autonomously decides to copy additional data, and subsequently informs the application layer by sending the message. In a practical embodiment the response from the FS to a command from the application layer to store a bridge clip may include the message.

FIG. 34 shows a flow diagram of a method of controlling recording of real-time information. The method is intended to be performed in a computer program, for example in a host computer controlling a recording device, but may also be implemented (partly) in the recording device in dedicated circuits, in state machines or in a microcontroller and firmware. The method has the following steps, leading to a final step RECORD 348 in which a recording unit is instructed to actually record the real-time information in data blocks based on logical addresses. In an initial step INPUT 341 the real-time information is received, e.g. from a broadcast or from a user video camera. The real-time information is packaged in units having unit numbers, e.g. the source packets and numbers as described above. In a step APPLICATION 342 application control information is created and adapted. The application control information includes clips of the real-time information, one clip comprising a clip info for accessing a clip stream of the units of real-time information via the unit numbers, and a playlist, the playlist comprising at least one playitem, the playitem indicating a part to be played of the real-time information in the clip, the playlist indicating in which order playitems have to be reproduced. Clips and playlist have been described above with reference to FIGS. 13-17. In a next step CREATE BRIDGE 343 a bridge clip is created for linking a first and a second playitem via the bridge clip in response to a user editing command. The bridge clip stream contains re-encoded real-time information based on an ending part of the first clip and a starting part of the second clip as explained with FIG. 32. In a next step FILE MGT 344 a file system is instructed to store the real-time information and the corresponding application control information created in steps 342 and 343. The file system step further includes retrieving ALLOCATION RULES 345 from a memory for storing the real-time information in the data blocks. The allocation rules 345 include a rule to store a stream of real-time information that is to be reproduced seamlessly in a sequence of extents of consecutive data blocks, the extents having at least a predefined extent length. The file system verifies the lengths of the extents based on the original application control information. If the lengths of the extents comply with the rules the recording step 348 is directly entered as indicated by line 349. If the lengths of the extents would violate the minimum extent length allocation rule, a next step COPY 346 is entered. Additional units of real-time information are copied from preceding and/or following clips stream files as described above, e.g. with FIGS. 29 and 33. By the copying of additional units of real-time information from a part of the first clip stream before the ending part of the first clip and/or from a part of the second clip stream after the starting part of the second clip the bridge clip stream is adapted to have at least the predefined extent length. In a next step ADAPT 347 the application control information is updated for accessing (during playback) the bridge clip stream including said additionally copied units. The file system reports the locations of the additionally copied units to the application management system for adapting the application control information as described above, e.g. with FIG. 24.

Whilst the invention has been described with reference to preferred embodiments thereof, in particular the BD format, it is to be understood that these are not limitative examples. For example the record carrier may alternatively be a magneto-optical or magnetic type. Thus, various modifications may become apparent to those skilled in the art, without departing from the scope of the invention, as defined by the claims.

Further, the invention lies in each and every novel feature or combination of features. The invention can be implemented by means of both hardware and software, and that several “means” may be represented by the same item of hardware. Furthermore, the word “comprising” does not exclude the presence of other elements or steps than those listed in the claims.

1. Device for recording real-time information on a record carrier (3), the device having
recording means (102) for recording data blocks based on logical addresses on the record carrier,
a file subsystem (303) for storing the real-time information in units having unit numbers (SPN) in the data blocks according to predefined allocation rules, which rules include storing a stream of real-time information that is to be reproduced seamlessly in a sequence of extents of consecutive data blocks, the extents having at least a predefined extent length, and
an application subsystem (8,302) for managing application control information, the application control information including
at least one clip of the real-time information, the clip comprising a clip info for accessing a clip stream of the units of real-time information via the unit numbers,
at least one playlist, the playlist comprising at least one playitem, the playitem indicating a part to be played of the real-time information in the clip, the playlist indicating in which order playitems have to be reproduced, and
at least one bridge clip for linking a first and a second playitem via the bridge clip, a bridge clip stream comprising re-encoded real-time information based on an ending part of the first clip and a starting part of the second clip,
the file subsystem (303) being arranged for copying additional units of real-time information from a part of the first clip stream before the ending part of the first clip and/or from a part of the second clip stream after the starting part of the second clip for creating the bridge clip stream having at least the predefined extent length, and
the application subsystem (8,302) being arranged for adapting the application control information for accessing the bridge clip stream including said additionally copied units.

2. Device as claimed in claim 1, wherein the file subsystem (303) is arranged for providing access information to the application subsystem for indicating the location of said additionally copied units.

3. Device as claimed in claim 2, wherein the file subsystem (303) is arranged for providing the access information by sending a message indicating the first unit that has been additionally copied by an exit unit number from the part of the first clip before the ending part of the first clip and/or indicating the last unit that has been additionally copied by an entry unit number to the part of the second clip after the starting part of the second clip.

4. Device as claimed in claim 1, wherein the file subsystem (303) is arranged for copying the units from the first clip stream before the ending part of the first clip and/or the units from the second clip stream after the starting part of the second clip for creating the bridge clip, and the application subsystem (8,302) is arranged adapting the application control information for accessing the bridge clip and skipping the first clip stream and/or the second clip stream.

5. Device as claimed in claim 1, wherein the file subsystem (303) is arranged for said copying by selecting a unit that is aligned with a start of a data block as the first unit that is to be additionally copied, or by selecting a unit that is aligned with an end of a data block as the last unit that is to be additionally copied.

6. Device as claimed in claim 5, wherein the recording means (102) are arranged for recording error correction blocks containing a predefined number of the data blocks, and the file subsystem (303) is arranged for said copying by selecting a unit that is aligned with a start of an error correction block as the first unit that is to be additionally copied, or by selecting a unit that is aligned with an end of an error correction block as the last unit that is to be additionally copied.

7. Method of controlling recording of real-time information in data blocks based on logical addresses, the method comprising
storing (348) the real-time information in units having unit numbers in the data blocks according to predefined allocation rules (345), which rules include storing a stream of real-time information that is to be reproduced seamlessly in a sequence of extents of consecutive data blocks, the extents having at least a predefined extent length,
managing (342) application control information, the application control information including
at least one clip of the real-time information, the clip comprising a clip info for accessing a clip stream of the units of real-time information via the unit numbers,
at least one playlist, the playlist comprising at least one playitem, the playitem indicating a part to be played of the real-time information in the clip, the playlist indicating in which order playitems have to be reproduced, and
at least one bridge clip (343) for linking a first and a second playitem via the bridge clip, a bridge clip stream comprising re-encoded real-time information based on an ending part of the first clip and a starting part of the second clip,
copying (346) additional units of real-time information from a part of the first clip stream before the ending part of the first clip and/or from a part of the second clip stream after the starting part of the second clip for creating the bridge clip stream having at least the predefined extent length, and
adapting (347) the application control information for accessing the bridge clip stream including said additionally copied units.

8. Computer program product for controlling recording of real-time information, which program is operative to cause a processor to perform the method as claimed in claim 7.

9. Record carrier carrying real-time information and corresponding application control information in data blocks based on logical addresses,
the real-time information being stored in units having unit numbers in the data blocks according to predefined allocation rules, which rules include storing a stream of real-time information that is to be reproduced seamlessly in a sequence of extents of consecutive data blocks, the extents having at least a predefined extent length,
the application control information including
at least one clip of the real-time information, the clip comprising a clip info for accessing a clip stream of the units of real-time information via the unit numbers,
at least one playlist, the playlist comprising at least one playitem, the playitem indicating a part to be played of the real-time information in the clip, the playlist indicating in which order playitems have to be reproduced, and
at least one bridge clip for linking a first and a second playitem via the bridge clip, a bridge clip stream comprising re-encoded real-time information based on an ending part of the first clip and a starting part of the second clip,
the bridge clip stream containing additional units of real-time information copied from a part of the first clip stream before the ending part of the first clip and/or from a part of the second clip stream after the starting part of the second clip for creating the bridge clip stream having at least the predefined extent length, and
the application control information including information for accessing the bridge clip stream including said additionally copied units.
